(19) United States
(12) Patent Application Publication
(10) Pub. No.: US 2018/0102805 A1
(43) Pub. Date: Apr. 12, 2018

(54) WIRELESS TERMINAL AND WIRELESS COMMUNICATION METHOD

(71) Applicant: KYOCERA CORPORATION, Kyoto (JP)

(72) Inventor: Akira UKON, Yokohama-shi, Kanagawa (JP)

(21) Appl. No.: 15/568,400

(22) PCT Filed: Mar. 31, 2016
(86) PCT No.: PCT/JP2016/060700

§ 371 Date: Oct. 20, 2017

(30) Foreign Application Priority Data
Apr. 23, 2015 (JP) 2015-088648

(51) Int. Cl. H04B 1/525; H04B 1/48; H04B 1/12; H04B 1/04

(52) U.S. Cl. CPC H04B 1/525; H04B 1/48; H04L 5/14; H04B 1/0475; H04B 1/123

(57) ABSTRACT

A first quadplexer receives a transmission signal in a first frequency band from a radio frequency transceiver and outputs the transmission signal to a first antenna, and receives a signal from the first antenna and outputs reception signals in third and fourth frequency bands to the radio frequency transceiver. A second quadplexer receives a transmission signal in a second frequency band from the radio frequency transceiver and outputs the transmission signal to a second antenna, and receives a signal from the second antenna and outputs reception signals in the third and fourth frequency bands to the radio frequency transceiver. The radio frequency transceiver converts a signal from the quadplexer into a baseband signal. A baseband IC subjects baseband signals generated from signals in the same frequency band to MIMO reception processing.

### TECHNICAL FIELD

The present disclosure relates to a wireless terminal and a wireless communication method.

### BACKGROUND ART

A wireless terminal with a carrier aggregation function has conventionally been known. For example, PTD 1 discloses a wireless terminal which can adapt to two wireless communication networks different from each other in an uplink frequency band and a downlink frequency band, can simultaneously transmit a plurality of uplink modulated transmission signals, and can simultaneously receive a plurality of downstream modulated reception signals.

### CITATION LIST

Patent Document

PTD 1: Japanese Patent Laying-Open No. 2011-119981

### SUMMARY OF INVENTION

### Technical Problem

PTD 1, however, fails to disclose a wireless terminal with both of a carrier aggregation function and a multiple-input and multiple-output (MIMO) reception function or a wireless terminal with both of a simultaneous communication function under long term evolution (LTE) and code division multiple access (CDMA) and a MIMO reception function.

Therefore, an object of the present disclosure is to provide a wireless terminal and a wireless communication method which can perform both of a carrier aggregation function and a MIMO reception function or both of a simultaneous communication function under LTE and CDMA and a MIMO reception function.

### Solution to Problem

A wireless terminal in one embodiment is capable of transmission using a first frequency band and a second frequency band and reception using a third frequency band and a fourth frequency band. The wireless terminal includes a first antenna, a second antenna, a radio frequency transceiver, a baseband processing unit, a first multiplexer, and a second multiplexer. The radio frequency transceiver is configured to convert a frequency of two systems of upstream baseband signals and output a transmission signal in the first frequency band and a transmission signal in the second frequency band. The baseband processing unit subjects a downstream signal received from the radio frequency transceiver and an upstream signal to be output to the radio frequency transceiver to baseband processing. The first multiplexer is configured to receive the transmission signal in the first frequency band from the radio frequency transceiver and output the transmission signal to the first antenna and configured to receive a signal from the first antenna and output a reception signal in the third frequency band and a reception signal in the fourth frequency band to the radio frequency transceiver. The second multiplexer is configured to receive the transmission signal in the second frequency band from the radio frequency transceiver and output the transmission signal to the second antenna and configured to receive a signal from the second antenna and output a reception signal in the third frequency band and a reception signal in the fourth frequency band to the radio frequency transceiver. The radio frequency transceiver is configured to generate a first signal and a second signal by converting a frequency of the reception signal in the third frequency band output from the first multiplexer and the reception signal in the third frequency band output from the second multiplexer into baseband signals. The radio frequency transceiver is configured to generate a third signal and a fourth signal by converting a frequency of the reception signal in the fourth frequency band output from the first multiplexer and the reception signal in the fourth frequency band output from the second multiplexer into baseband signals. The baseband processing unit is configured to obtain two systems of downstream baseband signals by subjecting the first signal and the second signal to MIMO reception processing and subjecting the third signal and the fourth signal to MIMO reception processing.

### Advantageous Effects of Invention

The wireless terminal in one embodiment can perform both of the carrier aggregation function and the MIMO reception function.

### BRIEF DESCRIPTION OF DRAWINGS

FIG. 1 is a diagram showing a configuration of a wireless terminal in an embodiment.

FIG. 2 is a diagram showing a frequency band of a wireless signal transmitted and received by the wireless terminal in a first embodiment.

FIG. 3 is a diagram showing a configuration of an antenna unit and a radio processing unit in the first embodiment.

FIG. 4 is a diagram showing a configuration of a first RF transceiver integrated circuit (IC) and a second RF transceiver IC.

FIG. 5 is a diagram showing a configuration of a B2-duplexer.

FIG. 6 is a diagram showing a configuration of a B4-duplexer.

FIG. 7 is a diagram showing a configuration of the antenna unit and the radio processing unit in a second embodiment.

FIG. 8 is a diagram showing a configuration of the antenna unit and the radio processing unit in a third embodiment.

FIG. 9 is a diagram showing a configuration of a quadplexer.

FIG. 10 is a diagram showing a configuration of the antenna unit and the radio processing unit in a fourth embodiment.

FIG. 11 is a diagram showing a configuration of a first quadplexer.

FIG. 12 is a diagram showing a configuration of a second quadplexer.

FIG. 13 is a diagram showing a frequency band of a wireless signal transmitted and received by a wireless terminal in a fifth embodiment.

FIG. 14 is a diagram showing a configuration of the antenna unit and the radio processing unit in the fifth embodiment.

FIG. 15 is a diagram showing a frequency band of a wireless signal transmitted and received by a wireless terminal in a sixth embodiment.

FIG. 16 is a diagram showing a configuration of the antenna unit and the radio processing unit in the sixth embodiment.

FIG. 17 is a diagram showing a frequency band of a wireless signal transmitted and received by a wireless terminal in a seventh embodiment.

FIG. 18 is a diagram showing a configuration of the antenna unit and the radio processing unit in the seventh embodiment.

### DESCRIPTION OF EMBODIMENTS

An embodiment will be described below with reference to the drawings.

A wireless terminal under LTE is assumed as a wireless terminal in the present disclosure. The wireless terminal in the present disclosure can transmit data by using a carrier aggregation technique in transmission. The wireless terminal in the present disclosure can receive data by using the carrier aggregation technique and a MIMO reception technique in reception.

In carrier aggregation transmission, a wireless terminal can simultaneously transmit signals in a plurality of different frequency bands with uplink data being located as being divided into the plurality of different frequency bands. In carrier aggregation reception, the wireless terminal simultaneously receives signals in a plurality of different frequency bands and obtains downlink data by integrating the received signals. In MIMO reception, the wireless terminal receives with a plurality of antennas, spatially multiplexed or space-time encoded signals in the same frequency band (referred to as a band A) transmitted from a plurality of antennas of a wireless base station and obtains data in band A by separating or decoding the received signals.

### First Embodiment

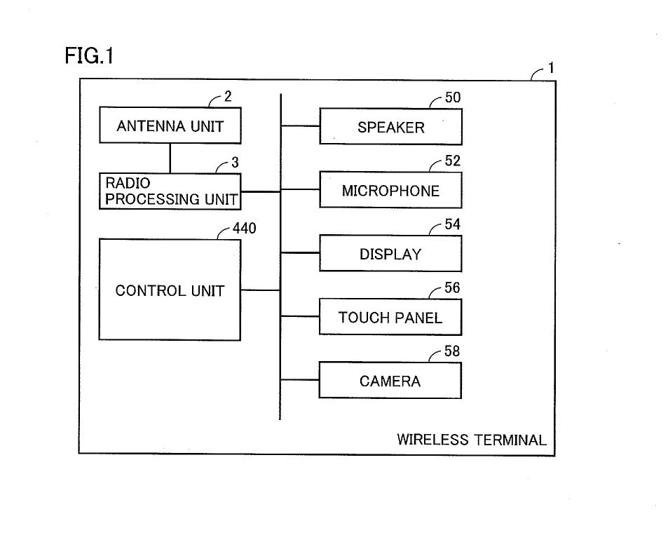

FIG. 1 is a diagram showing a configuration of a wireless terminal 1 in an embodiment.

Referring to FIG. 1, wireless terminal 1 includes an antenna unit 2, a radio processing unit 3, a control unit 440, a speaker 50, a microphone 52, a display 54, a touch panel 56, and a camera 58.

Radio processing unit 3 can communicate with a wireless base station through antenna unit 2.

Speaker 50 can output voice and sound of a communication counterpart output from control unit 440.

Microphone 52 can receive voice and sound of a user of wireless terminal 1 and output the voice and sound to control unit 440.

Display 54 can show a screen output from control unit 440.

Touch panel 56 can accept an input from a user.

Camera 58 can pick up an image of a subject.

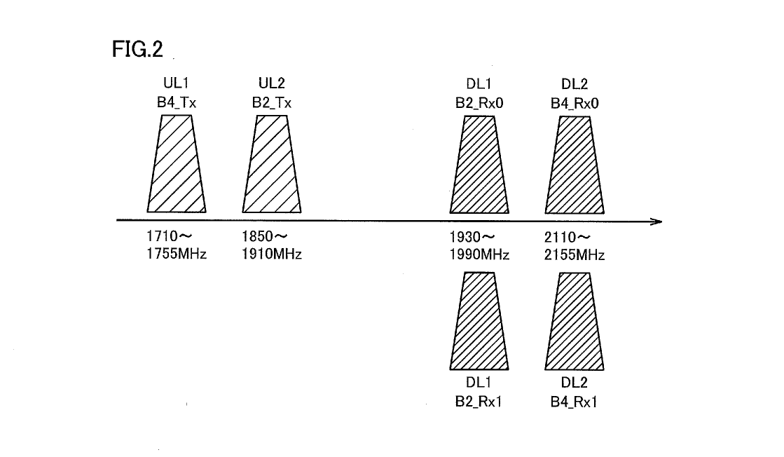

FIG. 2 is a diagram showing a frequency band of a wireless signal transmitted and received by wireless terminal 1 in a first embodiment. A frequency band of a transmission signal is B4_Tx (1710 to 1755 MHz) and B2_Tx (1850 to 1910 MHz). A frequency band of a reception signal is B2_Rx (1930 to 1990 MHz) and B4_Rx (2110 to 2155 MHz). In reception, for MIMO reception, wireless terminal 1 can receive a signal in a band of B2_Rx through one antenna (denoted as B2_Rx0) and receive a signal in the band of B2_Rx through another antenna (denoted as B2_Rx1) and can receive a signal in a band of B4_Rx through one antenna (denoted as B4_Rx0) and receive a signal in the band of B4_Rx through another antenna (denoted as B4_Rx1).

B2_Tx and B2_Rx are band names used in LTE and are generally referred to as personal communications service (PCS) 1900. B4_Tx and B4_Rx are band names used in LTE and are referred to as advanced wireless service (AWS) 1700.

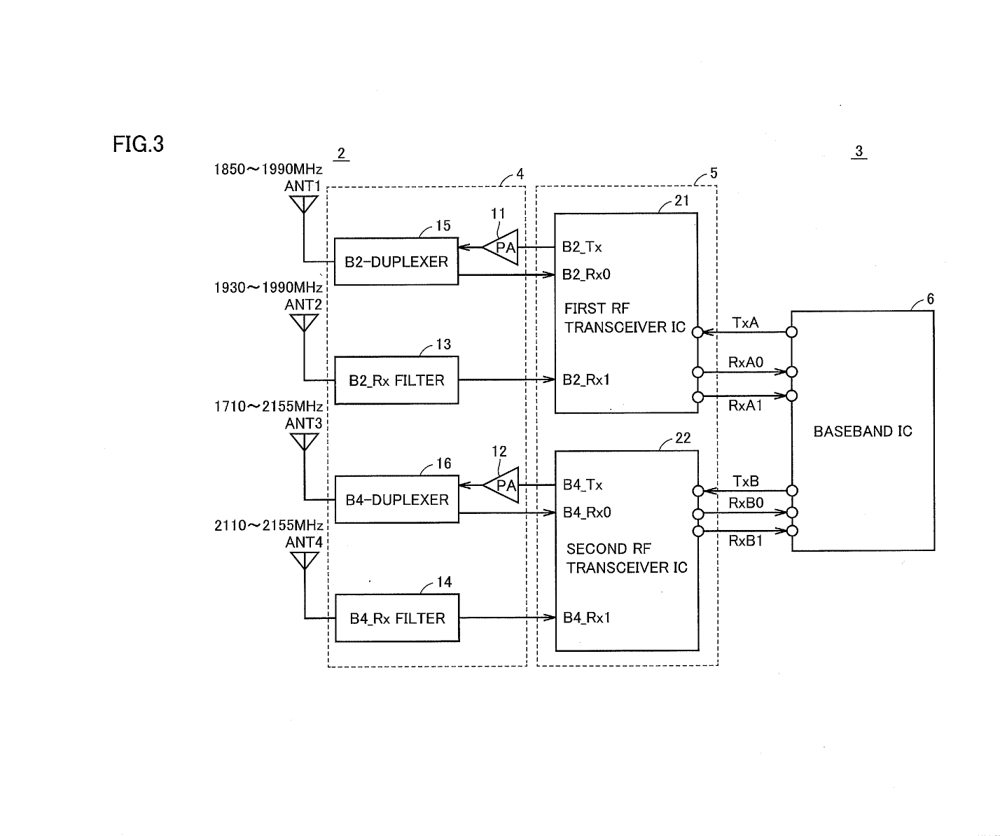

FIG. 3 is a diagram showing a configuration of antenna unit 2 and radio processing unit 3 in the first embodiment.

Radio processing unit 3 includes a branching unit 4, a radio frequency transceiver 5, and a baseband IC (baseband processing unit) 6.

Baseband IC 6 performs baseband processing for LTE. Specifically, baseband IC 6 subjects downlink data to such processing as channel decoding, discrete Fourier transform (DFT), demapping, Fourier transform (FFT), and data demodulation. Baseband IC 6 subjects uplink data to such processing as channel encoding, data modulation, mapping, and inverse Fourier transform (IFFT).

Baseband IC 6 subjects downlink data in the same frequency band received by two antennas to MIMO reception processing. Baseband IC 6 can perform processing for separating a spatially multiplexed signal when a wireless base station transmits a spatially multiplexed signal and can perform processing for decoding a time encoded signal when the wireless base station transmits a space-time encoded signal.

Baseband IC 6 can perform carrier aggregation transmission processing to divide downlink data into two systems of downlink data for a first RF transceiver IC 21 and downlink data for a second RF transceiver IC 22 under prescribed rules such as a round robin. Baseband IC 6 can subject the divided data to baseband processing for downlink data.

Baseband IC 6 can obtain data divided at the time of transmission by the wireless base station by performing carrier aggregation reception processing to subject data output from first RF transceiver IC 21 and data output from second RF transceiver IC 22 to baseband processing for uplink data as described above. Baseband IC 6 can regenerate original data by integrating the obtained divided data.

Antenna unit 2 includes a first antenna ANT1, a second antenna ANT2, a third antenna ANT3, and a fourth antenna ANT4.

First antenna ANT1 has a voltage standing wave ratio (VSWR) not greater than a prescribed value in a range from 1850 MHz to 1990 MHz. First antenna ANT1 can transmit a signal of B2_Tx and receive a signal of B2_Rx0. Second antenna ANT2 has a VSWR not greater than a prescribed value in a range from 1930 MHz to 1990 MHz. Second antenna ANT2 can receive a signal of B2_Rx1. Third antenna ANT3 has a VSWR not greater than a prescribed value in a range from 1710 MHz to 2155 MHz. Third antenna ANT3 can transmit a signal of B4_Tx and receive a signal of B4_Rx0. Fourth antenna ANT4 has a VSWR not greater than a prescribed value in a range from 2110 MHz to 2155 MHz. Fourth antenna ANT4 can receive a signal of B4_Rx1.

Radio frequency transceiver 5 includes first RF transceiver IC 21 and second RF transceiver IC 22.

First RF transceiver IC 21 can convert a frequency of a baseband signal and output a signal in the band of B2_Tx. First RF transceiver IC 21 can convert a frequency of two signals (B2_Rx0 and B2_Rx1) in the band of B2_Rx into baseband signals and output the baseband signals to baseband IC 6.

Second RF transceiver IC 22 can convert a frequency of a baseband signal and output a signal in the band of B4_Tx. Second RF transceiver IC 22 can convert a frequency of two signals (B4_Rx0 and B4_Rx1) in the band of B4_Rx into baseband signals and output the baseband signals to baseband IC 6.

Branching unit 4 includes a B2-duplexer 15, a power amplifier (PA) 11, a B2_Rx filter 13, a B4-duplexer 16, a power amplifier (PA) 12, and a B4_Rx filter 14.

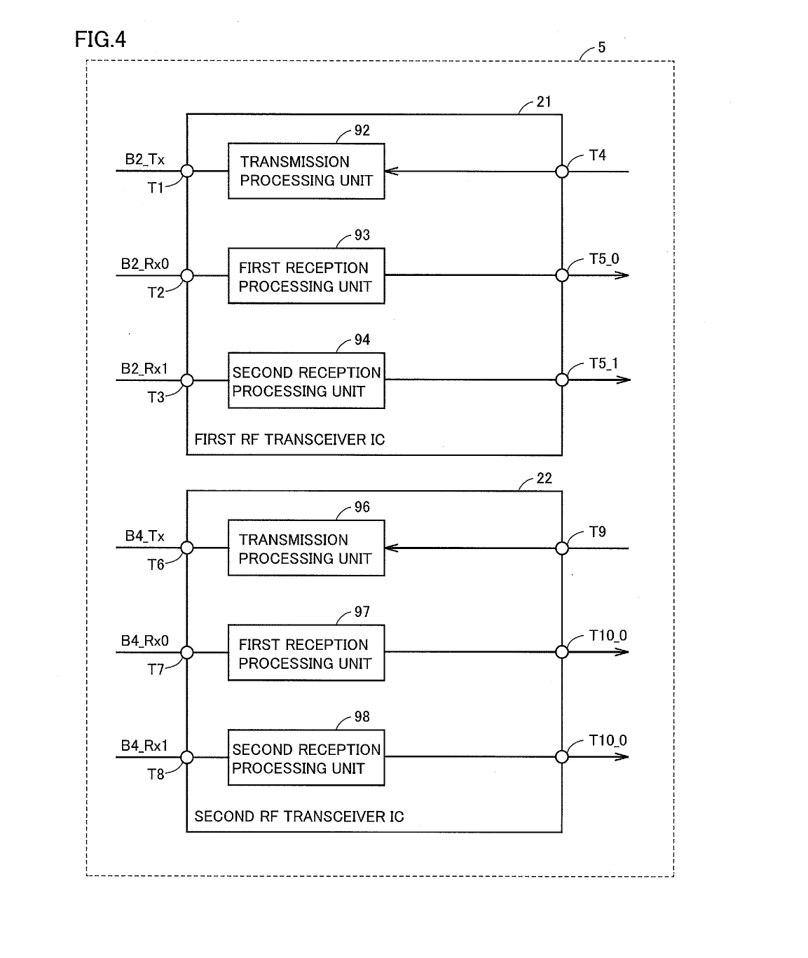

FIG. 4 is a diagram showing a configuration of first RF transceiver IC 21 and second RF transceiver IC 22.

Referring to FIG. 4, first RF transceiver IC 21 includes a transmission processing unit 92, a first reception processing unit 93, and a second reception processing unit 94.

A terminal T4 can receive a digital baseband signal from baseband IC 6. Transmission processing unit 92 can convert the baseband signal received by terminal T4 into an analog signal, thereafter convert a frequency of the analog signal into a signal in the band of B2_Tx, and output the signal from a terminal T1 to power amplifier 11.

A terminal T2 can receive a signal (B2_Rx0) in the band of B2_Rx from B2-duplexer 15. First reception processing unit 93 can amplify the signal of B2_Rx0 received by terminal T2, thereafter convert a frequency of the signal into a baseband signal, further convert the baseband signal into a digital signal, and output the digital signal from a terminal T5_0.

A terminal T3 can receive a signal (B2_Rx1) in the band of B2_Rx from B2_Rx filter 13. Second reception processing unit 94 can amplify the signal of B2_Rx1 received by terminal T3, thereafter convert a frequency of the signal into a baseband signal, further convert the baseband signal into a digital signal, and output the digital signal from a terminal T5_1.

Second RF transceiver IC 22 includes a transmission processing unit 96, a first reception processing unit 97, and a second reception processing unit 98.

A terminal T9 can receive a digital baseband signal from baseband IC 6. Transmission processing unit 96 can convert the baseband signal received by terminal T9 into an analog signal, thereafter convert a frequency of the analog signal into a signal in the band of B4_Tx, and output the signal from a terminal T6 to power amplifier 12.

A terminal T7 can receive a signal (B4_Rx0) in the band of B4_Rx from B4-duplexer 16. First reception processing unit 97 can amplify the signal of B4_Rx0 received by terminal T6, thereafter convert a frequency of the signal into a baseband signal, further convert the baseband signal into a digital signal, and output the digital signal from a terminal T10_0.

A terminal T8 can receive a signal (B4_Rx1) in the band of B4_Rx1 from B4_Rx filter 14. Second reception processing unit 98 can amplify the signal of B4_Rx1 received by terminal T8, thereafter convert a frequency of the signal into a baseband signal, further convert the baseband signal into a digital signal, and output the digital signal from a terminal T10_1.

Referring again to FIG. 3, power amplifier 11 can amplify electric power of the signal of B2_Tx output from first RF transceiver IC 21 and output the signal to B2-duplexer 15.

B2-duplexer 15 can extract a band component of B2_Rx from a signal output from first antenna ANT1 and outputs the band component to first RF transceiver IC 21. B2-duplexer 15 can output the signal of B2_Tx to first antenna ANT1.

B2_Rx filter 13 can allow passage of the band component of B2_Rx of a signal output from second antenna ANT2 and output a signal of B2_Rx1 to first RF transceiver IC 21.

Power amplifier 12 can amplify electric power of the signal of B4_Tx output from second RF transceiver IC 21 and output the signal to B4-duplexer 16.

B4-duplexer 16 extracts a band component of B4_Rx from a signal output from third antenna ANT3 and outputs the band component to second RF transceiver IC 22. B4-duplexer 16 can output a signal of B4_Tx to third antenna ANT3.

B4_Rx filter 14 can allow passage of the band component of B4_Rx of a signal output from fourth antenna ANT4 and output a signal of B4_Rx1 to second RF transceiver IC 22.

FIG. 5 is a diagram showing a configuration of B2-duplexer 15.

B2-duplexer 15 represents one type of a multiplexer, and can receive a transmission signal in a specific band from radio processing unit 3 and output the transmission signal to first antenna ANT1, and can simultaneously output a specific band component included in a signal received from first antenna ANT1 to radio processing unit 3.

B2-duplexer 15 includes terminals T11, T12, and T13, a transmission filter 72, and a reception filter 73.

Transmission filter 72 has a characteristic to allow passage of the band of B2_Tx. Reception filter 73 has a characteristic to allow passage of B2_Rx. Therefore, isolation from introduction of a transmission signal in the band of B2_Tx into a reception path can be ensured.

Terminal T12 can receive a signal of B2_Tx sent from power amplifier 11.

Transmission filter 72 can remove a band component (noise) other than B2_Tx from the signal of B2_Tx received by terminal T12 for output to terminal T11.

Terminal T11 can receive a reception signal from first antenna ANT1 and output the reception signal to reception filter 73. Though the reception signal from first antenna ANT1 flows also in a direction toward transmission filter 72, the reception signal from first antenna ANT1 does not affect a transmission signal because electric power of the transmission signal is higher than electric power of the reception signal. Terminal T11 can receive a signal of B2_Tx from transmission filter 72 and output the signal to first antenna ANT1.

Reception filter 73 can allow passage of the band component of B2_Rx from the signal output from terminal T11 and output the signal of B2_Rx0 from terminal T13 to first RF transceiver IC 21.

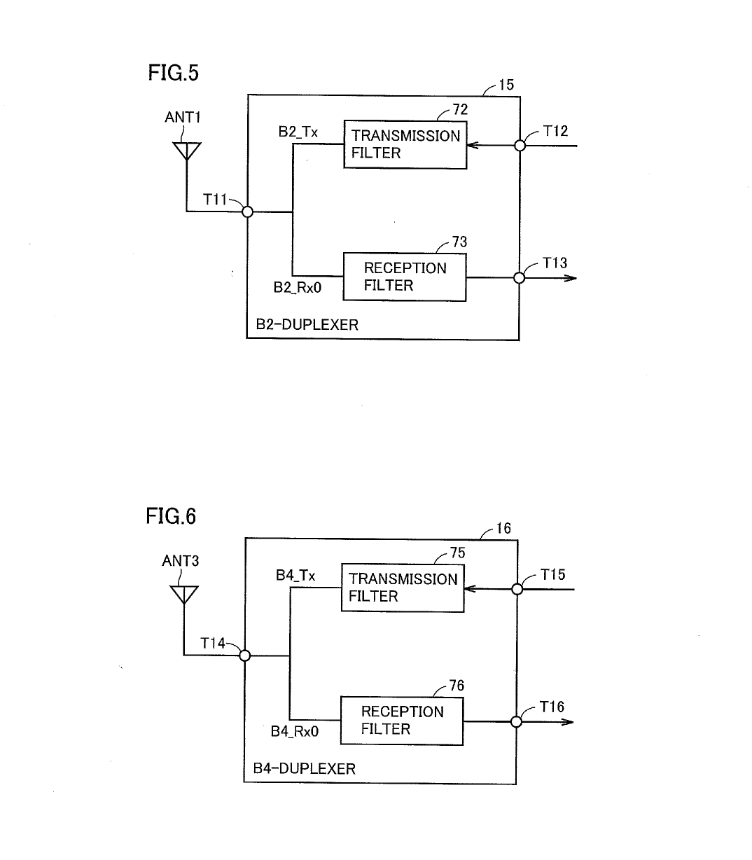

FIG. 6 is a diagram showing a configuration of B4-duplexer 16.

B4-duplexer 16 represents one type of a multiplexer, and can receive a transmission signal in a specific band from radio processing unit 3 and output the transmission signal to third antenna ANT3, and can simultaneously output a specific band component included in a signal received from third antenna ANT3 to radio processing unit 3.

B4-duplexer 15 includes terminals T14, T15, and T16, a transmission filter 75, and a reception filter 76.

Transmission filter 75 has a characteristic to allow passage of the band of B4_Tx. Reception filter 76 has a characteristic to allow passage of the band of B4_Rx, Therefore, isolation from introduction of a transmission signal in the band of B4_Tx into a reception path can be ensured.

Terminal T15 can receive a signal of B4_Tx sent from power amplifier 12.

Transmission filter 75 can remove a band component (noise) other than B4_Tx from the signal of B4_Tx received by terminal T15 for output to terminal T14.

Terminal T14 can receive a reception signal from third antenna ANT3 and output the reception signal to reception filter 76. Though the reception signal from third antenna ANT3 flows also in a direction toward transmission filter 75, the reception signal from third antenna ANT3 does not affect a transmission signal because electric power of the transmission signal is higher than electric power of the reception signal. Terminal T14 can receive a signal of B4_Tx from transmission filter 75 and output the signal to third antenna ANT3.

Reception filter 76 can allow passage of the band component of B4_Rx from the signal output from terminal T14 and output the signal of B4_Rx0 from terminal T16 to second RF transceiver IC 22.

A procedure for processing in transmission and a procedure for processing in reception will now be described.

(Transmission Processing)

Baseband IC 6 can divide uplink data into two systems of a baseband signal TxA and a baseband signal TxB, output baseband signal TxA to first RF transceiver IC 21, and output baseband signal TxB to second RF transceiver IC 22.

First RF transceiver IC 21 can receive baseband signal TxA and convert a frequency of the baseband signal into a signal in the band of B2_Tx. First RF transceiver IC 21 can output the signal in the band of B2_Tx to power amplifier 11.

Power amplifier 11 can amplify electric power of the signal in the band of B2_Tx and output the signal to B2-duplexer 15. B2-duplexer 15 can output the signal in the band of B2_Tx to first antenna ANT1 while it prevents introduction of the signal into a reception path. First antenna ANT1 capable of transmission of a signal in the band of B2_Tx can transmit the signal in the band of B2_Tx to the wireless base station.

Second RF transceiver IC 22 can receive baseband signal TxB and convert a frequency of the baseband signal into a signal in the band of B4_Tx. Second RF transceiver IC 22 can output the signal in the band of B4_Tx to power amplifier 12.

Power amplifier 12 can amplify electric power of the signal in the band of B4_Tx and output the signal to B4-duplexer 16. B4-duplexer 16 can output the signal in the band of B4_Tx to third antenna ANT3 while it prevents introduction of the signal into a reception path. Third antenna ANT3 capable of transmission of a signal in the band of B4_Tx can transmit the signal in the band of B4_Tx to the wireless base station.

Carrier aggregation transmission can be performed through the operations above.

(Reception Processing)

First antenna ANT1 capable of reception of a signal in the band of B2_Rx can receive a signal from the wireless base station and output the signal to B2-duplexer 15. B2-duplexer 15 can allow passage of the signal (B2_Rx0) in the band of B2_Rx and output the signal to first RF transceiver IC 21.

Second antenna ANT2 capable of reception of a signal in the band of B2_Rx can receive a signal from the wireless base station and output the signal to B2_Rx filter 13. B2_Rx filter 13 can allow passage of the signal (B2_Rx1) in the band of B2_Rx and output the signal to first RF transceiver IC 21.

First RF transceiver IC 21 can output a baseband signal RxA0 obtained by frequency conversion of the signal (B2_Rx0) in the band of B2_Rx output from B2-duplexer 15 to baseband IC 6. First RF transceiver IC 21 can output a baseband signal RxA1 obtained by frequency conversion of the signal (B2_Rx1) in the band of B2_Rx output from B2_Rx filter 13 to baseband IC 6.

Third antenna ANT3 capable of reception of a signal in the band of B4_Rx can receive a signal from the wireless base station and output the signal to B4-duplexer 16. B4-duplexer 16 can allow passage of the signal (B4_Rx0) in the band of B4_Rx and output the signal to second RF transceiver IC 22.

Fourth antenna ANT4 capable of reception of a signal in the band of B4_Rx can receive a signal from the wireless base station and output the signal to B4_Rx filter 14. B4_Rx filter 14 can allow passage of a signal (B4_Rx1) in the band of B4_Rx and output the signal to second RF transceiver IC 22.

Second RF transceiver IC 22 can output a baseband signal RxB0 obtained by frequency conversion of a signal (B4_Rx0) in the band of B4_Rx output from B4-duplexer 16 to baseband IC 6. Second RF transceiver IC 22 can output a baseband signal RxB1 obtained by frequency conversion of a signal (B4_Rx1) in the band of B4_Rx output from B4_Rx filter 14 to baseband IC 6.

Baseband IC 6 generates a signal RxA by subjecting baseband signal RxA0 and baseband signal RxA1 sent from first RF transceiver IC 21 to MIMO reception processing. Baseband IC 6 generates a signal RxB by subjecting baseband signal RxB0 and baseband signal RxB1 sent from second RF transceiver IC 22 to MIMO reception processing. Baseband IC 6 can generate downlink data by integrating signal RxA and signal RxB.

Carrier aggregation reception can be performed through the operations above.

The transmission processing and the reception processing described above can simultaneously be performed.

As set forth above, the wireless terminal in the first embodiment transmits two signals in frequency bands different from each other, receives two signals in band A with different antennas, and receives two signals in a band B with different antennas.

The wireless terminal can thus perform both of the carrier aggregation function and the MIMO reception function.

### Second Embodiment

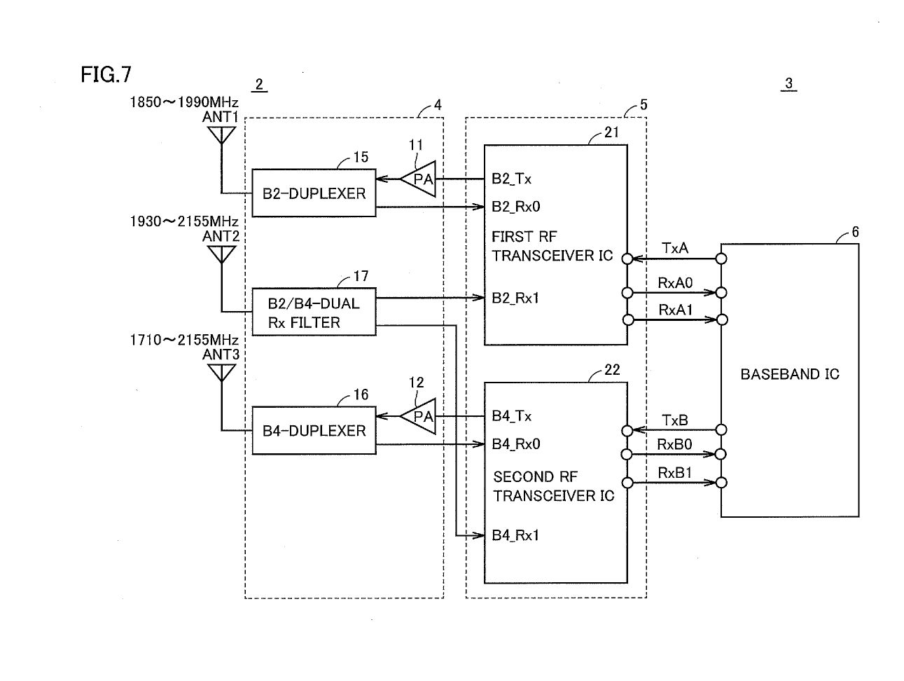

FIG. 7 is a diagram showing a configuration of antenna unit 2 and radio processing unit 3 in a second embodiment.

The second embodiment in FIG. 7 is different in configuration from the first embodiment in FIG. 3 as follows.

Antenna unit 2 in the second embodiment includes first antenna ANT1, second antenna ANT2, and third antenna ANT3.

First antenna ANT1 has a voltage standing wave ratio (VSWR) not greater than a prescribed value in a range from 1850 to 1990 MHz. First antenna ANT1 can transmit a signal of B2_Tx and receive a signal of B2_Rx0.

Second antenna ANT2 has a VSWR not greater than a prescribed value in a range from 1930 MHz to 2155 MHz. Second antenna ANT2 can receive signals of B2_Rx1 and B4_Rx1.

Third antenna ANT3 has a VSWR not greater than a prescribed value in a range from 1710 MHz to 2155 MHz. Third antenna ANT3 can transmit a signal of B4_Tx and receive a signal of B4_Rx0.

Branching unit 4 in the second embodiment includes a B2/B4-dual Rx filter 17 instead of B2_Rx filter 13 and B4_Rx filter 14 included in branching unit 4 in the first embodiment.

B2/B4-dual Rx filter 17 can allow passage of a band component of B2_Rx of a signal output from second antenna ANT2 and output a signal of B2_Rx1 to first RF transceiver IC 21, and can simultaneously allow passage of a band component of B4_Rx of a signal output from second antenna ANT2 and output a signal of B4_Rx1 to second RF transceiver IC 22.

(Transmission Processing)

Baseband IC 6 can divide uplink data into two systems of baseband signal TxA and baseband signal TxB, output baseband signal TxA to first RF transceiver IC 21, and output baseband signal TxB to second RF transceiver IC 22.

First RF transceiver IC 21 can receive baseband signal TxA and convert a frequency of the baseband signal into a signal in the band of B2_Tx. First RF transceiver IC 21 can output the signal in the band of B2_Tx to power amplifier 11.

Power amplifier 11 can amplify electric power of the signal in the band of B2_Tx and output the signal to B2-duplexer 15. B2-duplexer 15 can output the signal in the band of B2_Tx to first antenna ANT1 while it prevents introduction of the signal into a reception path. First antenna ANT1 capable of transmission of a signal in the band of B2_Tx can transmit the signal in the band of B2_Tx to the wireless base station.

Second RF transceiver IC 22 can receive baseband signal TxB and convert a frequency of the baseband signal into a signal in the band of B4_Tx. Second RF transceiver IC 22 can output the signal in the band of B4_Tx to power amplifier 12.

Power amplifier 12 can amplify electric power of the signal in the band of B4_Tx and output the signal to B4-duplexer 16. B4-duplexer 16 can output the signal in the band of B4_Rx to third antenna ANT3 while it prevents introduction of the signal into a reception path. Third antenna ANT3 capable of transmission of a signal in the band of B4_Rx can transmit the signal in the band of B4_Tx to the wireless base station.

Carrier aggregation transmission can be performed through the operations above.

(Reception Processing)

First antenna ANT1 capable of reception of a signal in the band of B2_Rx can receive a signal from the wireless base station and output the signal to B2-duplexer 15. B2-duplexer 15 can allow passage of the signal (B2_Rx0) in the band of B2_Rx and output the signal to first RF transceiver IC 21.

Third antenna ANT3 capable of reception of a signal in the band of B4_Rx can receive a signal from the wireless base station and output the signal to B4-duplexer 16. B4-duplexer 16 can allow passage of a signal in the band of B4_Rx (B4_Rx0) and output the signal to second RF transceiver IC 22.

Second antenna ANT2 capable of reception of signals in the band of B2_Rx and the band of B4_Rx can receive a signal from the wireless base station and output the signal to B2/B4-Rx filter 17. B2/B4_Rx filter 17 can allow passage of a signal (B2_Rx1) in the band of B2_Rx and output the signal to first RF transceiver IC 21, and can allow passage of a signal (B4_Rx1) in the band of B4_Rx and output the signal to second RF transceiver IC 22.

First RF transceiver IC 21 can output baseband signal RxA0 obtained by frequency conversion of the signal (B2_Rx0) in the band of B2_Rx output from B2-duplexer 15 to baseband IC 6. First RF transceiver IC 22 can output baseband signal RxA1 obtained by frequency conversion of the signal (B2_Rx1) in the band of B2_Rx output from B2/B4_Rx filter 17 to baseband IC 6.

Second RF transceiver IC 22 can output baseband signal RxB0 obtained by frequency conversion of a signal (B4_Rx0) in the band of B4_Rx output from B4-duplexer 16 to baseband IC 6. Second RF transceiver IC 22 can output baseband signal RxB1 obtained by frequency conversion of a signal (B4_Rx1) in the band of B4_Rx output from B2/B4_Rx filter 17 to baseband IC 6.

Baseband IC 6 can generate signal RxA by subjecting baseband signal RxA0 and baseband signal RxA1 sent from first RF transceiver IC 21 to MIMO reception processing. Baseband IC 6 can generate signal RxB by subjecting baseband signal RxB0 and baseband signal RxB1 sent from second RF transceiver IC 22 to MIMO reception processing. Baseband IC 6 can generate downlink data by integrating signal RxA and signal RxB.

Carrier aggregation reception can be performed through the operations above.

The transmission processing and the reception processing described above can simultaneously be performed.

As set forth above, the wireless terminal in the second embodiment can perform both of the carrier aggregation function and the MIMO reception function as in the first embodiment and can be smaller in number of antennas by one than in the first embodiment.

### Third Embodiment

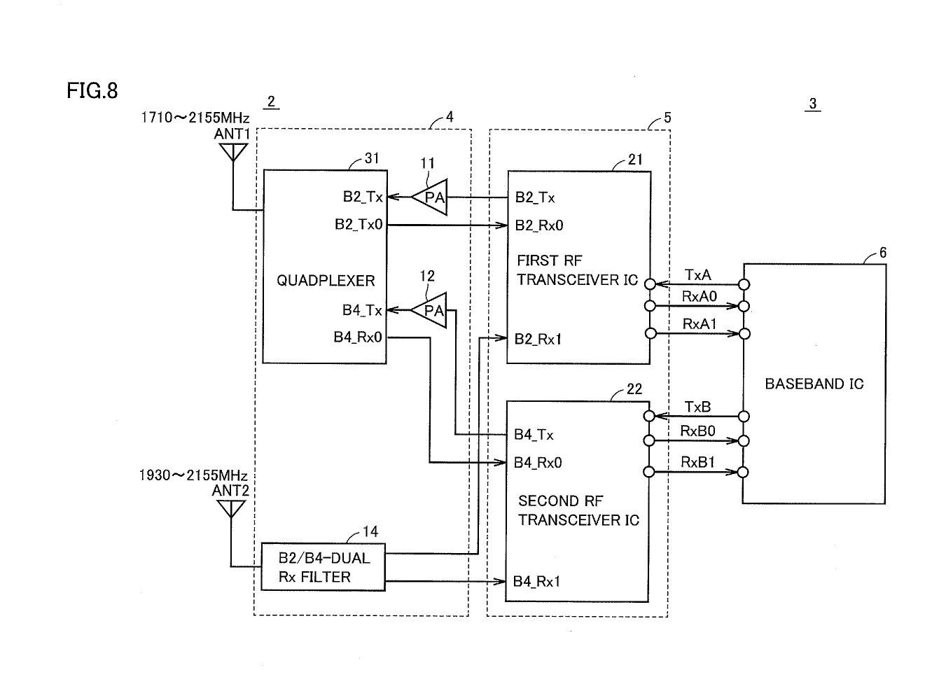

FIG. 8 is a diagram showing a configuration of antenna unit 2 and radio processing unit 3 in a third embodiment.

The third embodiment in FIG. 8 is different in configuration from the second embodiment in FIG. 7 as follows.

Antenna unit 2 in the third embodiment includes first antenna ANT1 and second antenna ANT2.

First antenna ANT1 has a voltage standing wave ratio (VSWR) not greater than a prescribed value in a range from 1710 to 2155 MHz. First antenna ANT1 can transmit a signal of B2_Tx and a signal of B4_Tx and receive signals of B2_Rx0 and B4_Rx0.

Second antenna ANT2 has a VSWR not greater than a prescribed value in a range from 1930 MHz to 2155 MHz. Second antenna ANT2 can receive a signal of B2_Rx1 and a signal of B4_Rx1.

Branching unit 4 in the third embodiment includes a quadplexer 31 instead of B2-duplexer 15 and B4-duplexer 16 included in branching unit 4 in the second embodiment.

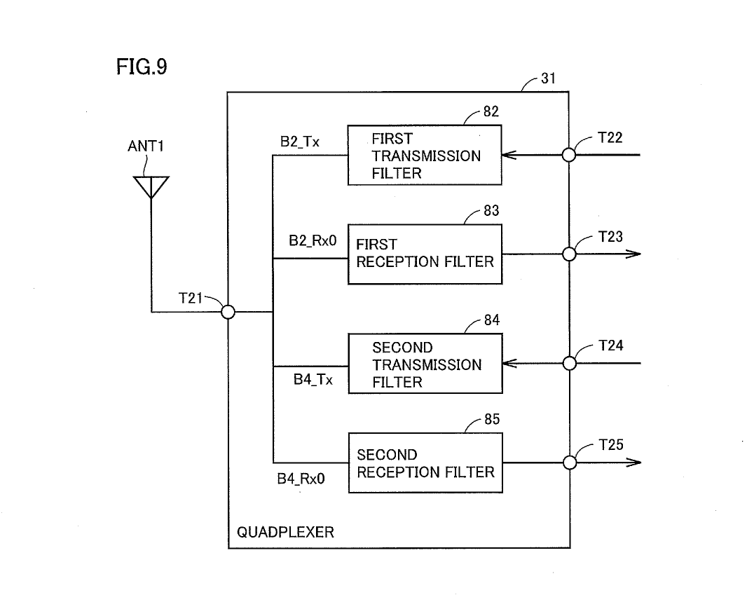

FIG. 9 is a diagram showing a configuration of quadplexer 31.

Quadplexer 31 represents one type of a multiplexer and can receive a transmission signal in a first specific band and a transmission signal in a second specific band from radio processing unit 3 and output the transmission signals to first antenna ANT1, and can simultaneously output a first specific band component and a second specific band component included in a signal received from first antenna ANT1 to radio processing unit 3.

Quadplexer 31 includes terminals T21 to T25, a first transmission filter 82, a first reception filter 83, a second transmission filter 84, and a second reception filter 85.

First transmission filter 82 has a characteristic to allow passage of a band of B2_Tx. First reception filter 83 has a characteristic to allow passage of B2_Rx.

Second transmission filter 84 has a characteristic to allow passage of a band of B4_Tx. Second reception filter 85 has a characteristic to allow passage of B4_Rx. Therefore, isolation from introduction of a transmission signal in the band of B2_Tx and a transmission signal in the band of B4_Tx into a reception path can be ensured.

Terminal T22 can receive a signal of B2_Tx sent from power amplifier 11. First transmission filter 82 can remove a band component (noise) other than B2_Tx from the signal of B2_Tx received by terminal T22 for output to terminal T21.

Terminal T24 can receive a signal of B4_Tx sent from power amplifier 12. Second transmission filter 84 can remove a band component (noise) other than B4_Tx from the signal of B4_Tx received by terminal T24 for output to terminal T21.

Terminal T21 can receive a reception signal from first antenna ANT1 and output the reception signal to first reception filter 83 and second reception filter 85. Though the reception signal from first antenna ANT1 flows also in directions toward first transmission filter 82 and second transmission filter 84, the reception signal from first antenna ANT1 does not affect a transmission signal because electric power of the transmission signal is higher than electric power of the reception signal. Terminal T21 can receive a signal of B2_Tx from first transmission filter 82 and output the signal to first antenna ANT1, and can receive a signal of B4_Tx from second transmission filter 84 and output the signal to first antenna ANT1.

First reception filter 83 can allow passage of a band component of B2_Rx from a signal output from terminal T21 and output a signal of B2_Rx0 from terminal T23 to first RF transceiver IC 21. Second reception filter 85 can allow passage of a band component of B4_Rx from a signal output from terminal T21 and output a signal of B4_Rx0 from terminal T25 to second RF transceiver IC 22.

(Transmission Processing)

Baseband IC 6 can divide uplink data into two systems of baseband signal TxA and baseband signal TxB, output baseband signal TxA to first RF transceiver IC 21, and output baseband signal TxB to second RF transceiver IC 22.

First RF transceiver IC 21 can receive baseband signal TxA and convert a frequency of the baseband signal into a signal in the band of B2_Tx. First RF transceiver IC 21 can output the signal in the band of B2_Tx to power amplifier 11.

Power amplifier 11 can amplify electric power of the signal in the band of B2_Tx and output the signal to quadplexer 31. Quadplexer 31 can output the signal in the band of B2 Tx to first antenna ANT1 while it prevents introduction of the signal into a reception path. First antenna ANT1 capable of transmission of a signal in the band of B2_Tx can transmit the signal in the band of B2_Tx to the wireless base station.

Second RF transceiver IC 22 can receive baseband signal TxB and convert a frequency of the baseband signal into a signal in the band of B4_Tx. Second RF transceiver IC 22 can output the signal in the band of B4_Tx to power amplifier 12.

Power amplifier 12 can amplify electric power of the signal in the band of B4_Tx and output the signal to quadplexer 31. Quadplexer 31 can output the signal in the band of B4_Tx to first antenna ANT1 while it prevents introduction of the signal into a reception path. First antenna ANT1 capable of transmission of the signal in the band of B4_Rx can transmit the signal in the band of B4_Tx to the wireless base station.

As set forth above, first antenna ANT1 can simultaneously transmit the signal in the band of B2_Tx and the signal in the band of B4_Tx.

Carrier aggregation transmission can be performed through the operations above.

(Reception Processing)

First antenna ANT1 capable of reception of signals in the band of B2_Rx and a B4_Rx band can receive a signal from the wireless base station and output the signal to quadplexer 31. Quadplexer 31 can allow passage of the signal (B2_Rx0) in the band of B2_Rx and output the signal to first RF transceiver IC 21, and can allow passage of a signal (B4_Rx0) in the band of B4_Rx and output the signal to second RF transceiver IC 22.

Second antenna ANT2 capable of reception of signals in the band of B2_Rx and the band of B4_Rx can receive a signal from the wireless base station and output the signal to B2/B4_Rx filter 17. B2/B4_Rx filter 17 can allow passage of a signal (B2_Rx1) in the band of B2_Rx and output the signal to first RF transceiver IC 21, and can allow passage of a signal (B4_Rx1) in the band of B4_Rx and output the signal to second RF transceiver IC 22.

First RF transceiver IC 21 can output baseband signal RxA0 obtained by frequency conversion of a signal (B2_Rx0) in the band of B2_Rx output from quadplexer 31 to baseband IC 6. First RF transceiver IC 21 can output baseband signal RxA1 obtained by frequency conversion of a signal (B2_Rx1) in the band of B2_Rx output from B2/B4_Rx filter 17 to baseband IC 6.

Second RF transceiver IC 22 can output baseband signal RxB0 obtained by frequency conversion of the signal (B4_Rx0) in the band of B4_Rx output from quadplexer 31 to baseband IC 6. Second RF transceiver IC 22 can output baseband signal RxB1 obtained by frequency conversion of the signal (B4_Rx1) in the band of B4_Rx output from B2/B4_Rx filter 17 to baseband IC 6.

Baseband IC 6 can generate signal RxA by subjecting baseband signal RxA0 and baseband signal RxA1 sent from first RF transceiver IC 21 to MIMO reception processing. Baseband IC 6 can generate signal RxB by subjecting baseband signal RxB0 and baseband signal RxB1 sent from second RF transceiver IC 22 to MIMO reception processing. Baseband IC 6 can generate downlink data by integrating signal RxA and signal RxB.

Carrier aggregation reception can be performed through the operations above.

The transmission processing and the reception processing described above can simultaneously be performed.

As set forth above, the wireless terminal in the third embodiment can perform both of the carrier aggregation function and the MIMO reception function as in the first and second embodiments and can be smaller in number of antennas by one than in the second embodiment.

### Fourth Embodiment

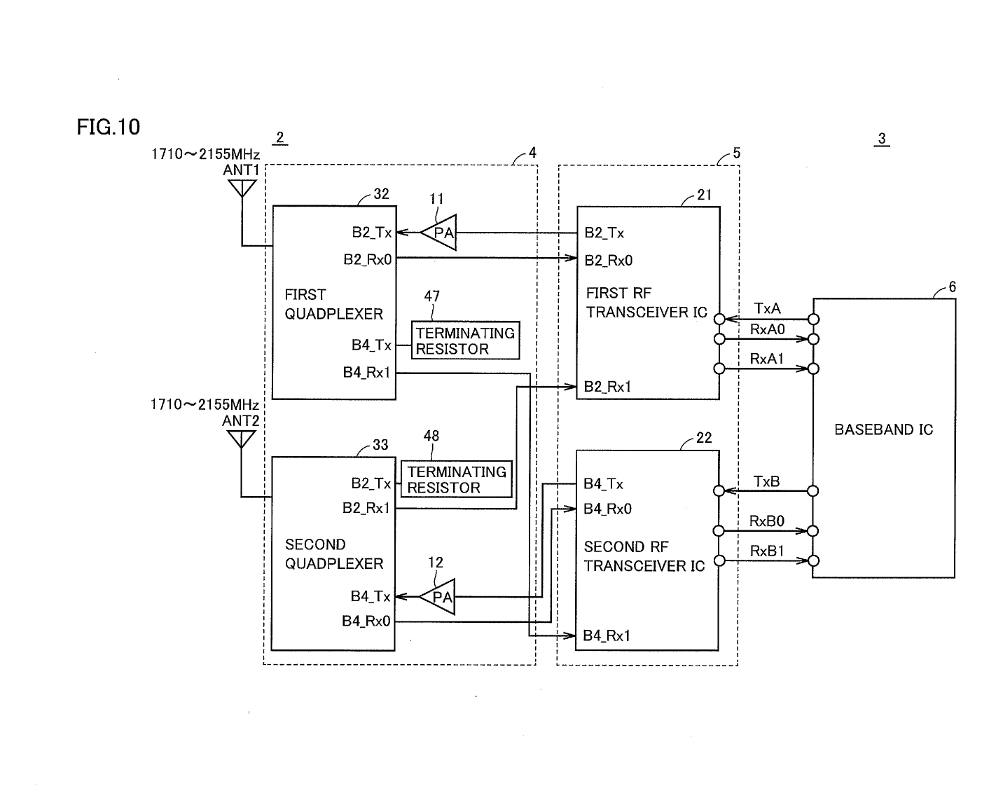

FIG. 10 is a diagram showing a configuration of antenna unit 2 and radio processing unit 3 in a fourth embodiment.

The fourth embodiment in FIG. 10 is different in configuration from the third embodiment in FIG. 8 as follows.

Antenna unit 2 in the fourth embodiment includes first antenna ANT1 and second antenna ANT2.

First antenna ANT1 has a voltage standing wave ratio (VSWR) not greater than a prescribed value in a range from 1710 to 2155 MHz. First antenna ANT1 can transmit a signal of B2_Tx and receive signals of B2_Rx0 and B4_Rx1.

Second antenna ANT2 has a VSWR not greater than a prescribed value in a range from 1710 MHz to 2155 MHz. Second antenna ANT2 can transmit a signal of B4_Tx and receive signals of B4_Rx0 and B2_Rx1.

Branching unit 4 in the fourth embodiment includes a first quadplexer (first multiplexer) 32 and a second quadplexer (second multiplexer) 33 instead of quadplexer 31 and B2/B4 dual Rx filter 14 included in branching unit 4 in the third embodiment.

FIG. 11 is a diagram showing a configuration of first quadplexer 32.

First quadplexer 32 represents one type of a multiplexer, and can receive a transmission signal in a specific band from radio processing unit 3 and output the transmission signal to first antenna ANT1, and can simultaneously output a first specific band component and a second specific band component included in a signal received from first antenna ANT1 to radio processing unit 3.

First quadplexer 32 includes a first terminal T31, a second terminal T32, a third terminal T33, a fourth terminal T34, a fifth terminal T35, a first transmission filter 42, a first reception filter 43, a second transmission filter 44, and a second reception filter 45.

First transmission filter 42 has a characteristic to allow passage of a band of B2_Tx. First reception filter 43 has a characteristic to allow passage of B2_Rx. Therefore, isolation from introduction of a transmission signal in the band of B2_Tx into a reception path can be ensured.

Second transmission filter 44 has a characteristic to allow passage of a prescribed band. Second reception filter 45 has a characteristic to allow passage of B4_Rx. Terminal T32 can receive a signal of B2_Tx sent from power amplifier 11. First transmission filter 42 can remove a band component (noise) other than B2_Tx from the signal of B2_Tx received by terminal T32 for output to terminal T31.

Terminal T34 is terminated by a terminating resistor 47. No signal is output from second transmission filter 44 connected to terminal T34.

Terminal T31 can receive a reception signal from first antenna ANT1 and output the reception signal to first reception filter 43 and second reception filter 45. Though the reception signal from first antenna ANT1 flows also in a direction toward first transmission filter 42, the reception signal from first antenna ANT1 does not affect a transmission signal because electric power of the transmission signal is higher than electric power of the reception signal. Terminal T31 can receive a signal of B2_Tx from first transmission filter 42 and output the signal to first antenna ANT1.

First reception filter 43 can allow passage of a band component of B2_Rx from the signal output from terminal T31 and output a signal of B2_Rx0 from terminal T33 to first RF transceiver IC 21. Second reception filter 45 can allow passage of a band component of B4_Rx from the signal output from terminal T31 and output a signal of B4_Rx1 from terminal T35 to second RF transceiver IC 22.

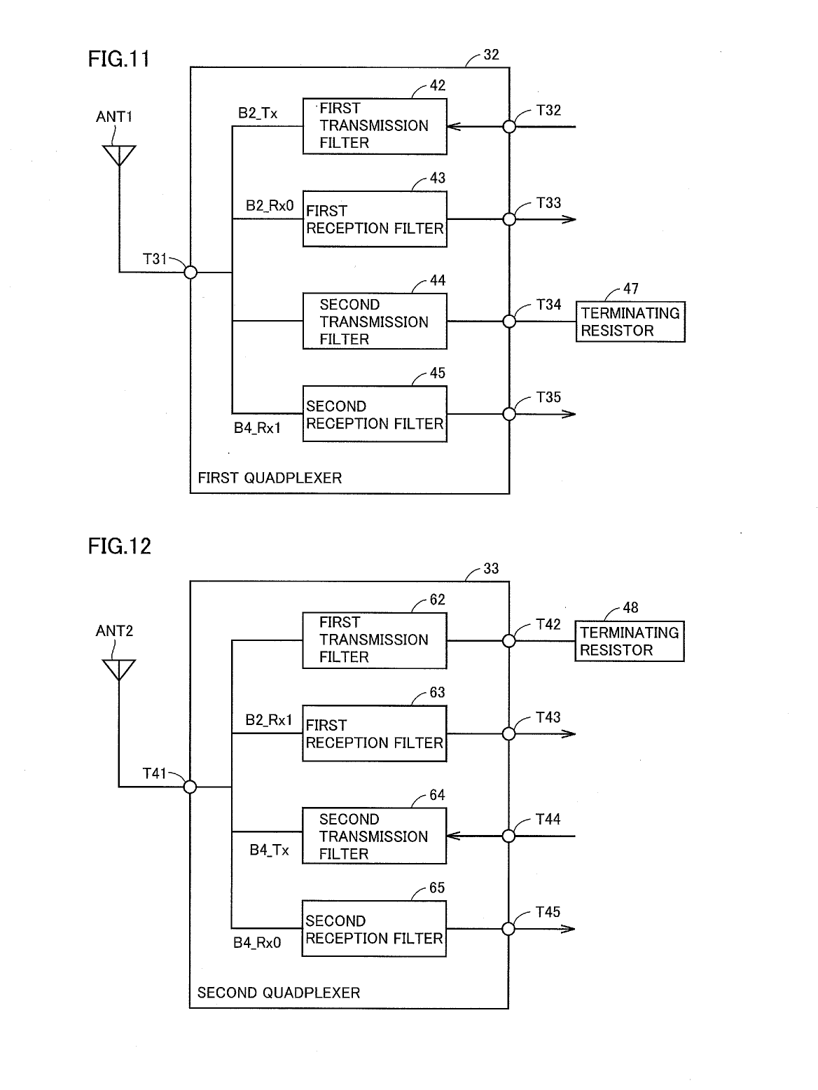

FIG. 12 is a diagram showing a configuration of second quadplexer 33.

Second quadplexer 33 represents one type of a multiplexer, and can receive a transmission signal in a specific band from radio processing unit 3 and output the transmission signal to second antenna ANT2, and can simultaneously output a first specific band component and a second specific band component included in a signal received form second antenna ANT2 to radio processing unit 3.

Second quadplexer 33 includes a first terminal T41, a second terminal T42, a third terminal T43, a fourth terminal T44, a fifth terminal T45, a first transmission filter 62, a first reception filter 63, a second transmission filter 64, and a second reception filter 65.

Second transmission filter 64 has a characteristic to allow passage of a band of B4_Rx. Second reception filter 65 has a characteristic to allow passage of B4_Rx. Therefore, isolation from introduction of a transmission signal in the band of B4_Tx into a reception path can be ensured.

First transmission filter 62 has a characteristic to allow passage of a prescribed band. First reception filter 63 has a characteristic to allow passage of B2_Rx.

Terminal T44 can receive a signal of B4_Tx sent from power amplifier 12. Second transmission filter 64 can remove a band component (noise) other than B4_Tx from the signal of B4_Tx received by terminal T44 for output to terminal T41.

Terminal T42 is terminated by a terminating resistor 48. No signal is output from first transmission filter 62 connected to terminal T42.

Terminal T41 can receive a reception signal from second antenna ANT2 and output the reception signal to first reception filter 63 and second reception filter 65. Though the reception signal from second antenna ANT2 flows also in a direction toward second transmission filter 64, the reception signal from second antenna ANT2 does not affect a transmission signal because electric power of the transmission signal is higher than electric power of the reception signal. Terminal T41 can receive a signal of B4_Tx from second transmission filter 64 and output the signal to second antenna ANT2.

First reception filter 63 can allow passage of a band component of B2_Rx from a signal output from terminal T41 and output a signal of B2_Rx1 from terminal T43 to first RF transceiver IC 21. Second reception filter 65 can allow passage of a band component of B4_Rx from the signal output from terminal T41 and output a signal of B4_Rx0 from terminal T45 to second RF transceiver IC 22.

(Transmission Processing)

Baseband IC 6 can divide uplink data into two systems of baseband signal TxA and baseband signal TxB, output baseband signal TxA to first RF transceiver IC 21, and output baseband signal TxB to second RF transceiver IC 22.

First RF transceiver IC 21 can receive baseband signal TxA and convert a frequency of the baseband signal into a signal in the band of B2_Tx. First RF transceiver IC 21 can output the signal in the band of B2_Tx to power amplifier 11.

Power amplifier 11 can amplify electric power of the signal in the band of B2_Tx and output the signal to first quadplexer 32. First quadplexer 32 can output the signal in the band of B2_Tx to first antenna ANT1 while it prevents introduction of the signal into a reception path. First antenna ANT1 capable of transmission of a signal in the band of B2_Tx can transmit the signal in the band of B2_Tx to the wireless base station.

Second RF transceiver IC 22 can receive baseband signal TxB and convert a frequency of the baseband signal into a signal in the band of B4_Tx. Second RF transceiver IC 22 can output a signal in the band of B4_Tx to power amplifier 12.

Power amplifier 12 can amplify electric power of the signal in the band of B4_Tx and output the signal to second quadplexer 33. Second quadplexer 33 can output the signal in the band of B4_Tx to second antenna ANT2 while it prevents introduction of the signal into a reception path. Second antenna ANT2 capable of transmission of the signal in the band of B4_Tx can transmit the signal in the band of B4_Rx to the wireless base station.

As set forth above, first antenna ANT1 and second antenna ANT2 can simultaneously transmit the signal in the band of B2_Tx and the signal in the band of B4_Rx.

Carrier aggregation transmission can be performed through the operations above.

(Reception Processing)

First antenna ANT1 capable of reception of signals in the band of B2_Rx and the band of B4_R can receive a signal from the wireless base station and output the signal to first quadplexer 32. First quadplexer 32 can allow passage of the signal (B2_Rx0) in the band of B2_Rx and output the signal to first RF transceiver IC 21, and can allow passage of a signal (B4_Rx1) in the band of B4_Rx and output the signal to second RF transceiver IC 22.

Second antenna ANT2 capable of reception of signals in the band of B2_Rx and the band of B4_Rx can receive a signal from the wireless base station and output the signal to second quadplexer 33. Second quadplexer 33 can allow passage of a signal (B2_Rx1) in the band of B2_Rx and output the signal to first RF transceiver IC 21, and can allow passage of a signal (B4_Rx0) in the band of B4_Rx and output the signal to second RF transceiver IC 22.

First RF transceiver IC 21 can output baseband signal RxA0 obtained by frequency conversion of a signal (B2_Rx0) in the band of B2_Rx output from first quadplexer 32 to baseband IC 6. First RF transceiver IC 21 can output baseband signal RxA1 obtained by frequency conversion of a signal (B2_Rx1) in the band of B2_Rx output from second quadplexer 33 to baseband IC 6.

Second RF transceiver IC 22 can output baseband signal RxB0 obtained by frequency conversion of a signal (B4_Rx1) in the band of B4_Rx output from first quadplexer 32 to baseband IC 6. Second RF transceiver IC 22 can output baseband signal RxB1 obtained by frequency conversion of a signal (B4_Rx0) in the band of B4_Rx output from second quadplexer 33 to baseband IC 6.

Baseband IC 6 can generate signal RxA by subjecting baseband signal RxA0 and baseband signal RxA1 sent from first RF transceiver IC 21 to MIMO reception processing. Baseband IC 6 can generate signal RxB by subjecting baseband signal RxB0 and baseband signal RxB1 sent from second RF transceiver IC 22 to MIMO reception processing. Baseband IC 6 can generate downlink data by integrating signal RxA and signal RxB.

Carrier aggregation reception can be performed through the operations above.

The transmission processing and the reception processing described above can simultaneously be performed.

As set forth above, the wireless terminal in the fourth embodiment can perform both of the carrier aggregation function and the MIMO reception function as in the first to third embodiments and can be smaller in number of antennas by one than in the second embodiment as in the third embodiment. In the wireless terminal in the third embodiment, transmission signals in two bands are processed by a single quadplexer and output to a single antenna. In contrast, in the wireless terminal in the fourth embodiment, transmission signals in two bands are processed by different quadplexers and output to different antennas. The wireless terminal in the fourth embodiment can thus more effectively prevent interference of transmission waves than the wireless terminal in the third embodiment.

### Fifth Embodiment

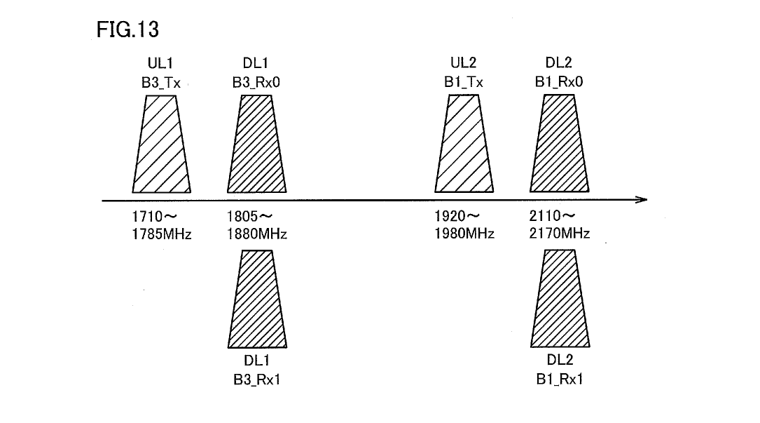

FIG. 13 is a diagram showing a frequency band of a wireless signal transmitted and received by wireless terminal 1 in a fifth embodiment. A frequency band of a transmission signal is B3_Tx (1710 to 1785 MHz) and B1_Tx (1920 to 1980 MHz). A frequency band of a reception signal is B3_Rx (1805 to 1880 MHz) and B1_Rx (2110 to 2170 MHz). In reception, for MIMO reception, wireless terminal 1 can receive a signal in a band of B3_Rx through one antenna (denoted as B3_Rx0) and receive a signal in the band of B3_Rx through another antenna (denoted as B3_Rx1) and can receive a signal in a band of B1_Rx through one antenna (denoted as B1_Rx0) and receive a signal in the band of B1_Rx through another antenna (denoted as B1_Rx1).

B1_Tx and B1_Rx are band names used in LTE and are generally referred to as international mobile telecommunication (IMT) 2100. B3_Tx and B3_Rx are band names used in LTE and are referred to as digital cellular service (DCS) 1800.

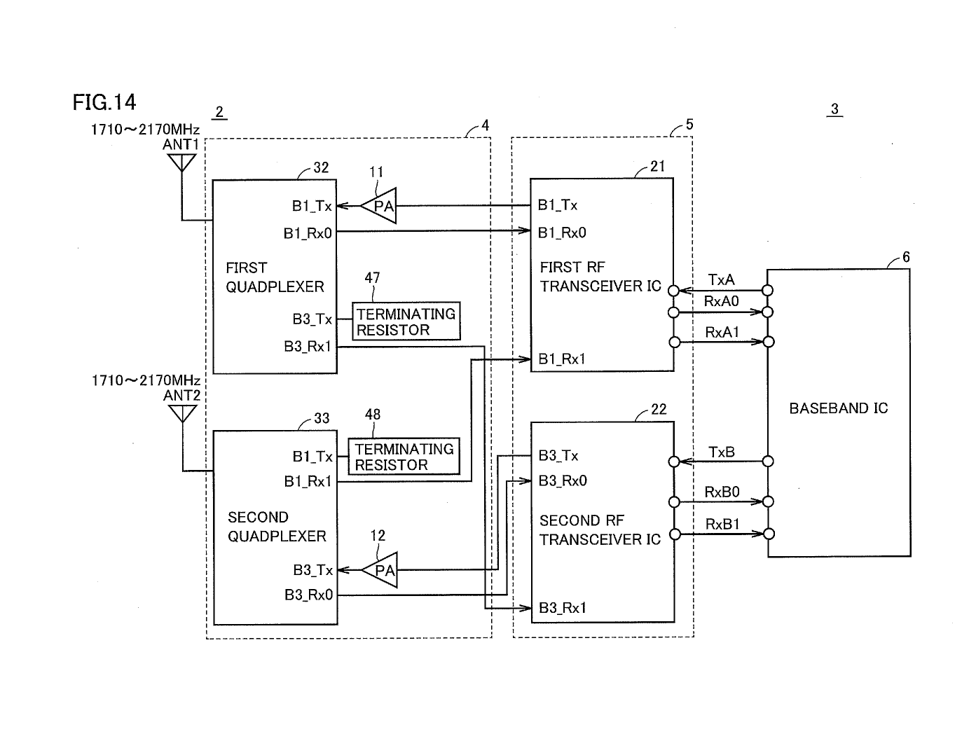

FIG. 14 is a diagram showing a configuration of antenna unit 2 and radio processing unit 3 in the fifth embodiment.

Antenna unit 2 in the fifth embodiment includes first antenna ANT1 and second antenna ANT2.

First antenna ANT1 has a voltage standing wave ratio (VSWR) not greater than a prescribed value in a range from 1710 MHz to 2170 MHz. First antenna ANT1 can transmit a signal of B1_Tx and receive signals of B1_Rx0 and B3_Rx1.

Second antenna ANT2 has a VSWR not greater than a prescribed value in a range from 1710 MHz to 2170 MHz. Second antenna ANT2 can transmit a signal of B3_Tx and receive signals of B3_Rx0 and B1_Rx1.

Branching unit 4 in the fifth embodiment is different from branching unit 4 in the fourth embodiment as follows.

First quadplexer 32 in the fifth embodiment processes a signal of B1_Tx instead of a signal of B2_Tx, processes a signal of B1_Rx0 instead of a signal of B2_Rx0, and processes a signal of B3_Rx1 instead of a signal of B4_Rx1.

Second quadplexer 33 in the fifth embodiment processes a signal of B3_Tx instead of a signal of B4_Tx, processes a signal of B3_Rx0 instead of a signal of B4_Rx0, and processes a signal of B1_Rx1 instead of a signal of B2_Rx1.

(Transmission Processing)

Baseband IC 6 can divide uplink data into two systems of baseband signal TxA and baseband signal TxB, output baseband signal TxA to first RF transceiver IC 21, and output baseband signal TxB to second RF transceiver IC 22.

First RF transceiver IC 21 can receive baseband signal TxA and convert a frequency of the baseband signal into a signal in the band of B1_Tx. First RF transceiver IC 21 can output the signal in the band of B1_Tx to power amplifier 11.

Power amplifier 11 can amplify electric power of the signal in the band of B1_Tx and output the signal to first quadplexer 32. First quadplexer 32 can output the signal in the band of B1_Tx to first antenna ANT1 while it prevents introduction of the signal into a reception path. First antenna ANT1 capable of transmission of a signal in the band of B1_Tx can transmit the signal in the band of B1_Tx to the wireless base station.

Second RF transceiver IC 22 can receive baseband signal TxB and convert a frequency of the baseband signal into a signal in the band of B3_Tx. Second RF transceiver IC 22 can output the signal in the band of B3_Tx to power amplifier 12.

Power amplifier 12 can amplify electric power of the signal in the band of B3_Tx and output the signal to second quadplexer 33. Second quadplexer 33 can output the signal in the band of B3_Tx to second antenna ANT2 while it prevents introduction of the signal into a reception path. Second antenna ANT2 capable of transmission of a signal in the band of B3_Tx can transmit the signal in the band of B3_Tx to the wireless base station.

As set forth above, first antenna ANT1 and second antenna ANT2 can simultaneously transmit the signal in the band of B1_Tx and the signal in the band of B3_Tx.

Carrier aggregation transmission can be performed through the operations above.

(Reception Processing)

First antenna ANT1 capable of reception of signals in the band of B1_Rx and the band of B3_R can receive a signal from the wireless base station and output the signal to first quadplexer 32. First quadplexer 32 can allow passage of the signal (B1_Rx0) in the band of B1_Rx and output the signal to first RF transceiver IC 21, and can allow passage of a signal (B3_Rx1) in the band of B3_Rx and output the signal to second RF transceiver IC 22.

Second antenna ANT2 capable of reception of signals in the band of B1_Rx and the band of B3_Rx can receive a signal from the wireless base station and output the signal to second quadplexer 33. Second quadplexer 33 can allow passage of a signal (B1_Rx1) in the band of B1_Rx and output the signal to first RF transceiver IC 21, and can allow passage of a signal (B3_Rx0) in the band of B3_Rx and output the signal to second RF transceiver IC 22.

First RF transceiver IC 21 can output a baseband signal RxxA0 obtained by frequency conversion of a signal (B1_Rx0) in the band of B1_Rx output from first quadplexer 32 to baseband IC 6. First RF transceiver IC 21 can output baseband signal RxA1 obtained by frequency conversion of a signal (B1_Rx1) in the band of B1_Rx output from second quadplexer 33 to baseband IC 6.

Second RF transceiver IC 22 can output baseband signal RxB0 obtained by frequency conversion of the signal (B3_Rx1) in the band of B3_Rx output from first quadplexer 32 to baseband IC 6. Second RF transceiver IC 22 can output baseband signal RxB1 obtained by frequency conversion of the signal (B3_Rx0) in the band of B3_Rx output from second quadplexer 33 to baseband IC 6.

Baseband IC 6 can generate signal RxA by subjecting baseband signal RxA0 and baseband signal RxA1 sent from first RF transceiver IC 21 to MIMO reception processing. Baseband IC 6 can generate signal RxB by subjecting baseband signal RxB0 and baseband signal RxB1 sent from second RF transceiver IC 22 to MIMO reception processing. The baseband IC can generate downlink data by integrating signal RxA and signal RxB.

Carrier aggregation reception can be performed through the operations above.

The transmission processing and the reception processing described above can simultaneously be performed.

As set forth above, the wireless terminal in the fifth embodiment achieves an effect the same as in the fourth embodiment by using bands B1 and B3 instead of bands B2 and B4 used in the wireless terminal in the fourth embodiment.

### Sixth Embodiment

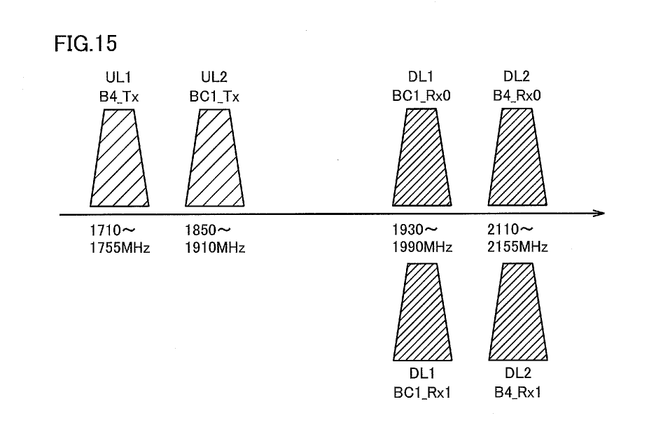

FIG. 15 is a diagram showing a frequency band of a wireless signal transmitted and received by wireless terminal 1 in a sixth embodiment. A frequency band of a transmission signal is B4_Tx (1710 to 1755 MHz) and BC1_Tx (1850 to 1910 MHz). A frequency band of a reception signal is BC1_Rx (1930 to 1990 MHz) and B4_Rx (2110 to 2155 MHz). In reception, for MIMO reception, wireless terminal 1 can receive a signal in a band of BC1_Rx through one antenna (denoted as BC1_Rx0) and receive a signal in the band of BC1_Rx through another antenna (denoted as (BC1_Rx1), and can receive a signal in a band of B4_Rx through one antenna (denoted as B4_Rx0) and receive a signal in the band of B4_Rx through another antenna (denoted as B4_Rx1).

BC1_Tx and BC1_Rx are band names used in CDMA and are generally referred to as PCS 1900.

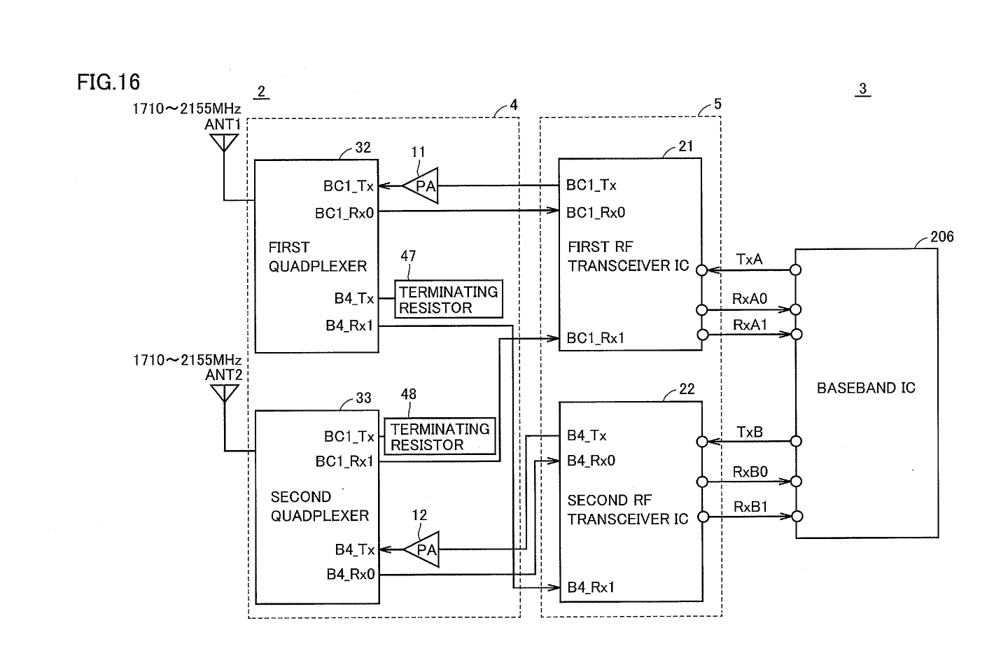

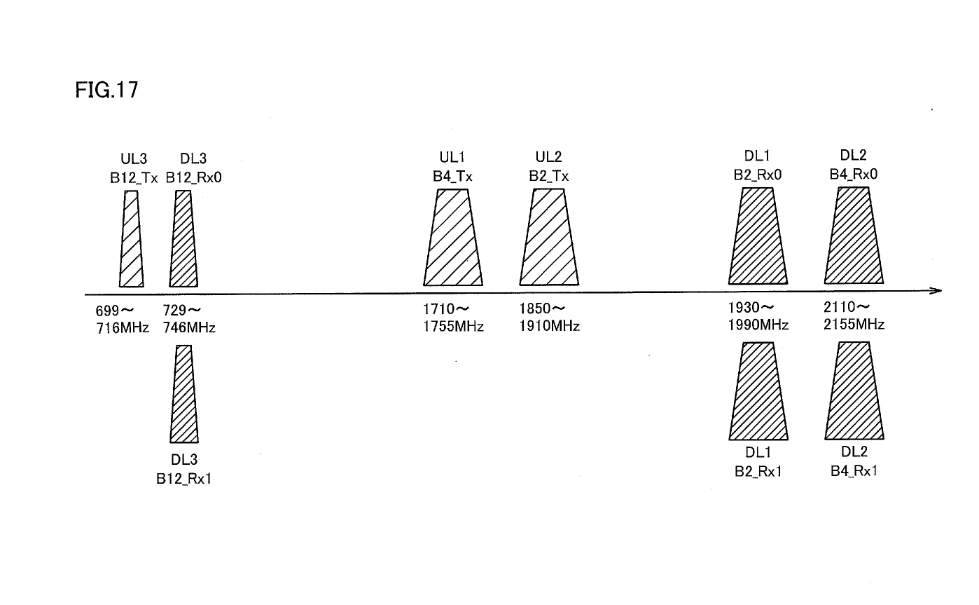

FIG. 16 is a diagram showing a configuration of antenna unit 2 and radio processing unit 3 in the sixth embodiment.

A baseband IC (baseband processing unit) 206 subjects data output to second RF transceiver IC 22 and data output from second RF transceiver IC 22 to baseband processing for LTE and subjects audio data output to first RF transceiver IC 21 and audio data output from first RF transceiver IC 21 to baseband processing for CDMA.

Specifically, baseband IC 206 subjects uplink audio data to such processing as error correction coding, data modulation, and spread modulation. Baseband IC 206 subjects downlink audio data to such processing as synchronization processing, inverse spread, and data demodulation. Baseband IC 206 can perform maximal ratio combining diversity processing of diversity reception processing on a signal of a system corresponding to CDMA.

Antenna unit 2 in the sixth embodiment is the same as described in the fourth embodiment and radio processing unit 3 in the sixth embodiment is the same as described in the fourth embodiment, because BC1 Tx is identical in band to B2 Tx.

Branching unit 4 in the sixth embodiment is the same as described in the fourth embodiment, first quadplexer 32 is the same as first quadplexer 32 in the fourth embodiment, and second quadplexer 33 is the same as second quadplexer 33 in the fourth embodiment, because BC1_Tx is identical in band to B2_Tx.

(Transmission Processing)

Baseband IC 206 can generate baseband signal TxA under CDMA standards from uplink audio data, generate baseband signal TxB under LTE standards from uplink data, output baseband signal TxA to first RF transceiver IC 21, and output baseband signal TxB to second RF transceiver IC 22.

First RF transceiver IC 21 can receive baseband signal TxA and convert a frequency of the baseband signal into a signal in the band of BC1_Tx. First RF transceiver IC 21 can output a signal in the band of BC1_Tx to power amplifier 11.

Power amplifier 11 can amplify electric power of the signal in the band of BC1_Tx and output the signal to first quadplexer 32. First quadplexer 32 can output the signal in the band of BC1_Tx to first antenna ANT1 while introduction of the signal into a reception path is prevented. First antenna ANT1 capable of transmission of the signal in the band of BC1_Tx can transmit the signal in the band of BC1_Tx to the wireless base station.

Second RF transceiver IC 22 can receive baseband signal TxB and convert a frequency of the baseband signal into a signal in the band of B4_Tx. Second RF transceiver IC 22 can output the signal in the band of B4_Tx to power amplifier 12.

Power amplifier 12 can amplify electric power of the signal in the band of B4_Tx and output the signal to second quadplexer 33. Second quadplexer 33 can output the signal in the band of B4_Tx to second antenna ANT2 while introduction of the signal into a reception path is prevented. Second antenna ANT2 capable of transmission of the signal in the band of B4_Tx can transmit the signal in the band of B4_Rx to the wireless base station.

As above, first antenna ANT1 and second antenna ANT2 can simultaneously transmit the signal in the band of BC1_Tx and the signal in the band of B4_Tx.

Through the operations above, sound transmission under CDMA and data transmission under LTE can simultaneously be performed.

(Reception Processing)

First antenna ANT1 capable of reception of signals in the band of BC1_Rx and the band of B4_R can receive a signal from the wireless base station and output the signal to first quadplexer 32. First quadplexer 32 can allow passage of a signal (BC1_Rx0) in the band of BC1_Rx and output the signal to first RF transceiver IC 21, and can allow passage of a signal (B4_Rx1) in the band of B4_Rx and output the signal to second RF transceiver IC 22.

Second antenna ANT2 capable of reception of signals in the band of BC1_Rx and the band of B4_Rx can receive a signal from the wireless base station and output the signal to second quadplexer 33. Second quadplexer 33 can allow passage of a signal (BC1_Rx1) in the band of BC1_Rx and output the signal to first RF transceiver IC 21, and can allow passage of a signal (B4_Rx0) in the band of B4_Rx and output the signal to second RF transceiver IC 22.

First RF transceiver IC 21 can output baseband signal RxA0 obtained by frequency conversion of a signal (BC1_Rx0) in the band of BC1_Rx output from first quadplexer 32 to baseband IC 6. First RF transceiver IC 21 can output baseband signal RxA1 obtained by frequency conversion of a signal (BC1_Rx1) in the band of BC1_Rx output from second quadplexer 33 to baseband IC 206.

Second RF transceiver IC 22 can output baseband signal RxB0 obtained by frequency conversion of the signal (B4_Rx1) in the band of B4_Rx output from first quadplexer 32 to baseband IC 6. Second RF transceiver IC 22 can output baseband signal RxB1 obtained by frequency conversion of the signal (B4_Rx0) in the band of B4_Rx output from second quadplexer 33 to baseband IC 206.

Baseband IC 206 can generate signal RxA by subjecting baseband signal RxA0 and baseband signal RxA1 sent from first RF transceiver IC 21 to maximal ratio combining diversity reception processing. Baseband IC 206 can generate audio data from signal RxA under CDMA standards. Baseband IC 206 can generate signal RxB by subjecting baseband signal RxB0 and baseband signal RxB1 sent from second RF transceiver IC 22 to MIMO reception processing. Baseband IC 206 can generate data from signal RxB under LTE standards.

Through the operations above, sound reception under CDMA and data reception under LTE can simultaneously be performed.

The transmission processing and the reception processing described above can simultaneously be performed.

As set forth above, the wireless terminal in the sixth embodiment can perform both of the simultaneous communication function under CDMA and LTE and the MIMO reception function, and can be smaller in number of antennas by one than in the second embodiment.

### Seventh Embodiment

FIG. 17 is a diagram showing a frequency band of a wireless signal transmitted and received by wireless terminal 1 in a seventh embodiment. A frequency band of a transmission signal is B4_Tx (1710 to 1755 MHz), B2_Tx (1850 to 1910 MHz), and B12_Tx (729 MHz to 746 MHz). A frequency band of a reception signal is B2_Rx (1930 to 1990 MHz), B4_Rx (2110 to 2155 MHz), and B12_Rx (699 MHz to 716 MHz). In reception, for MIMO reception, wireless terminal 1 can receive a signal in the band of B2_Rx through one antenna (denoted as B2_Rx0) and receive a signal in the band of B2_Rx through another antenna (denoted as B2_Rx1), can receive a signal in a band of B4_Rx through one antenna (denoted as B4_Rx0) and receive a signal in the band of B4_Rx through another antenna (denoted as B4_Rx1), and can further receive a signal in a band of B12_Rx through one antenna (denoted as B12_Rx0) and receive a signal in the band of B12_Rx through another antenna (denoted as B12_Rx1).

B12_Tx and B12_Rx are band names used in LTE and are generally referred to as SMH 700.

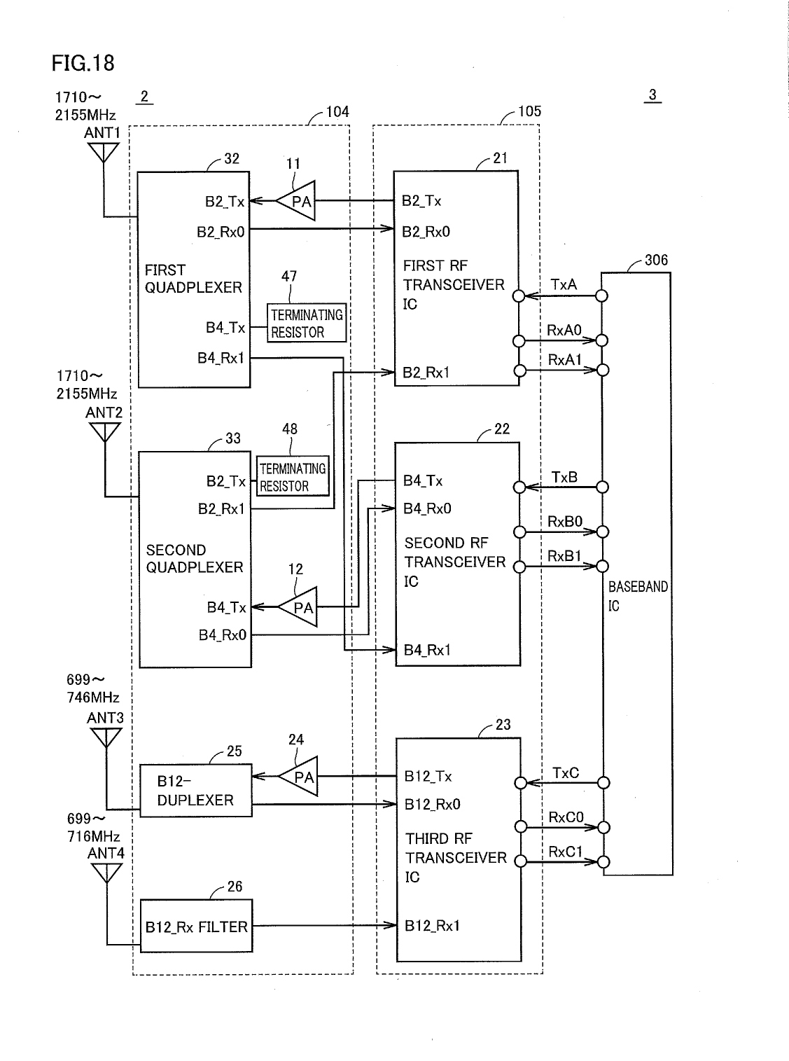

FIG. 18 is a diagram showing a configuration of antenna unit 2 and radio processing unit 3 in the seventh embodiment.

A baseband IC (baseband processing unit) 306 performs baseband processing for LTE.

Baseband IC 306 can perform carrier aggregation transmission processing to divide downlink data into three systems of data for first RF transceiver IC 21, data for second RF transceiver IC 22, and data for a third RF transceiver IC 23 under prescribed rules such as round robin. Baseband IC 306 can subject the divided data to baseband processing for downlink data.

Baseband IC 306 can perform carrier aggregation reception processing to obtain data divided at the time of transmission in the wireless base station by subjecting data output from first RF transceiver IC 21, data output from second RF transceiver IC 22, and data output from third RF transceiver IC 23 to baseband processing for uplink data. Baseband IC 306 can regenerate original data by integrating the obtained divided data.

Baseband IC 306 subjects downlink data in the same frequency band received by two antennas to MIMO reception processing. Baseband IC 306 can perform processing for separating a spatially multiplexed signal when the wireless base station transmits a spatially multiplexed signal and can perform processing for decoding a time encoded signal when the wireless base station transmits a space-time encoded signal.

Antenna unit 2 includes first antenna ANT1, second antenna ANT2, third antenna ANT3, and fourth antenna ANT4.

Since first antenna ANT1 and second antenna ANT2 are the same as described in the fourth embodiment, description will not be repeated.

Third antenna ANT3 has a VSWR not greater than a prescribed value in a range from 699 MHz to 746 MHz. Third antenna ANT3 can transmit a signal of B12_Tx and simultaneously receive a signal of B12_Rx.

Fourth antenna ANT4 has a VSWR not greater than a prescribed value in a range from 699 MHz to 716 MHz. Fourth antenna ANT4 can receive a signal of B12_Rx.

A branching unit 104 includes a power amplifier 24, a B12-duplexer (third multiplexer) 25, and a B12_Rx filter (filter) 26, in addition to first quadplexer 32, second quadplexer 33, power amplifier 11, and power amplifier 12 as in the fourth embodiment.

Power amplifier 24 can amplify electric power of a signal of B12_Tx output from third RF transceiver IC 23 and output the signal to B12-duplexer 25.

B12-duplexer 25 can extract a band component of B12_Rx from a signal output from third antenna ANT3 and output the band component to third RF transceiver IC 23. B12-duplexer 25 can output a signal of B12_Tx to third antenna ANT3.

B12_Rx filter 26 can allow passage of a band component of B12_Rx of a signal output from fourth antenna ANT4 and output a signal of B12_Rx1 to third RF transceiver IC 23.

Third RF transceiver IC 23 can convert a frequency of a baseband signal and output a signal in the band of B12_Tx. Third RF transceiver IC 23 can convert a frequency of two signals (B12_Rx0 and B12_Rx1) in the band of B12_Rx into baseband signals and can further subject the baseband signals to MIMO reception processing.

(Transmission Processing)

Baseband IC 306 can divide uplink data into two systems of baseband signal TxA, baseband signal TxB, and a baseband signal TxC, and output baseband signal TxA to first RF transceiver IC 21, output baseband signal TxB to second RF transceiver IC 22, and output baseband signal TxC to third RF transceiver IC 23.

First RF transceiver IC 21 can receive baseband signal TxA and convert a frequency of the baseband signal into a signal in the band of B2_Tx. First RF transceiver IC 21 can output the signal in the band of B2_Tx to power amplifier 11.

Power amplifier 11 can amplify electric power of the signal in the band of B2_Tx and output the signal to first quadplexer 32. First quadplexer 32 can output the signal in the band of B2_Tx to first antenna ANT1 while introduction of the signal into a reception path is prevented. First antenna ANT1 capable of transmission of a signal in the band of B2_Tx can transmit the signal in the band of B2_Tx to the wireless base station.

Second RF transceiver IC 22 can receive baseband signal TxB and convert a frequency of the baseband signal into a signal in the band of B4_Tx. Second RF transceiver IC 22 can output the signal in the band of B4_Tx to power amplifier 12.

Power amplifier 12 can amplify electric power of the signal in the band of B4_Tx and output the signal to second quadplexer 33. Second quadplexer 33 can output the signal in the band of B4_Tx to second antenna ANT2 while introduction of the signal into a reception path is prevented. Second antenna ANT2 capable of transmission of a signal in the band of B4_Tx can transmit the signal in the band of B4_Rx to the wireless base station.

Third RF transceiver IC 23 can receive baseband signal TxC and convert a frequency of the baseband signal into a signal in the band of B12_Tx. Third RF transceiver IC 23 can output the signal in the band of B12_Tx to power amplifier 24.

Power amplifier 24 can amplify electric power of the signal in the band of B12_Tx and output the signal to B12-duplexer 25. B12-duplexer 25 can output the signal in the band of B12_Tx to third antenna ANT3 while introduction of the signal into a reception path is prevented. Third antenna ANT3 capable of transmission of a signal in the band of B12_Tx can transmit the signal in the band of B12_Tx to the wireless base station.

As set forth above, first antenna ANT1, second antenna ANT2, and third antenna ANT3 can simultaneously transmit a signal in the band of B2_Tx, a signal in the band of B4_Tx, and a signal in the band of B12_Tx.

Carrier aggregation transmission can be performed through the operations above.

(Reception Processing)

First antenna ANT1 capable of reception of signals in the band of B2_Rx and the band of B4_R can receive a signal from the wireless base station and output the signal to first quadplexer 32. First quadplexer 32 can allow passage of a signal (B2_Rx0) in the band of B2_Rx and output the signal to first RF transceiver IC 21 and can allow passage of a signal (B4_Rx1) in the band of B4_Rx and output the signal to second RF transceiver IC 22.

Second antenna ANT2 capable of reception of signals in the band of B2_Rx and the band of B4_Rx can receive a signal from the wireless base station and output the signal to second quadplexer 33. Second quadplexer 33 can allow passage of a signal (B2_Rx1) in the band of B2_Rx and output the signal to first RF transceiver IC 21, and can allow passage of a signal (B4_Rx0) in the band of B4_Rx and output the signal to second RF transceiver IC 22.

First RF transceiver IC 21 can output baseband signal Rx0 obtained by frequency conversion of a signal (B2_Rx0) in the band of B2_Rx output from first quadplexer 32 to baseband IC 306. Baseband IC 306 can output baseband signal RxA1 obtained by frequency conversion of a signal (B2_Rx1) in the band of B2_Rx output from second quadplexer 33 to baseband IC 306.

Second RF transceiver IC 22 can output baseband signal RxB0 obtained by frequency conversion of a signal (B4_Rx1) in the band of B4_Rx output from first quadplexer 32 to baseband IC 306. Baseband IC 306 can output baseband signal RxB1 and a signal (B4_Rx0) in the band of B4_Rx output from second quadplexer 33 to baseband IC 306.

Third antenna ANT3 capable of reception of a signal in the band of B12_Rx can receive a signal from the wireless base station and output the signal to B12_Rx filter 25. B12_Rx filter 25 can allow passage of a signal (B12_Rx0) in the band of B12_Rx and output the signal to third RF transceiver IC 23.

Fourth antenna ANT4 capable of reception of a signal in the band of B12_Rx can receive a signal from the wireless base station and output the signal to B12_Rx filter 26. B12_Rx filter 26 can allow passage of a signal (B12_Rx1) in the band of B12 Rx and output the signal to third RF transceiver IC 23.

Third RF transceiver IC 23 can output a baseband signal RxC0 obtained by frequency conversion of a signal (B12_Rx0) in the band of B12_Rx output from B12-duplexer 25 to baseband IC 306. Third RF transceiver IC 23 can output a baseband signal RxC1 obtained by frequency conversion of a signal (B12_Rx1) in the band of B12_Rx output from B12_Rx filter 26 to baseband IC 306.

Baseband IC 306 can generate signal RxA by subjecting baseband signal RxA0 and baseband signal RxA1 sent from first RF transceiver IC 21 to MIMO reception processing. Baseband IC 306 can generate signal RxB by subjecting baseband signal RxB0 and baseband signal RxB1 sent from second RF transceiver IC 22 to MIMO reception processing. Baseband IC 306 can generate a signal RxC by subjecting baseband signal RxC0 and baseband signal RxC1 sent from third RF transceiver IC 23 to MIMO reception processing. Baseband IC 306 can generate downlink data by integrating signal RxA, signal RxB, and signal RxC.

Carrier aggregation reception can be performed through the operations above.

The transmission processing and the reception processing described above can simultaneously be performed.

As set forth above, the seventh embodiment achieves an effect the same as in the fourth embodiment. According to the seventh embodiment, the number of bands for transmission and reception are set to three and throughput in transmission and reception can be increased as compared with that in the fourth embodiment.

(Modification)

The present disclosure is not limited to the embodiments above. A modification below is also encompassed in the present disclosure.

(1) Though the radio processing unit is configured with two or three ICs in the embodiments above, limitation thereto is not intended. Functions of the plurality of ICs may be mounted on a single IC.

(2) Though the wireless terminal in the seventh embodiment is expansion of the wireless terminal in the fourth embodiment such that transmission and reception in three bands can be performed, the wireless terminals in the first to third embodiments can similarly be expanded to be capable of transmission and reception in three bands. Though the wireless terminal in the seventh embodiment carries out carrier aggregation for three bands, limitation thereto is not intended. A wireless terminal may carry out carrier aggregation for two bands and may transmit and receive independent data by using one remaining band.

(3) Though a quadplexer in which input of one transmission filter is terminated is employed in the third to seventh embodiments, limitation thereto is not intended. For example, a triplexer without a terminated filter may be employed.

It should be understood that the embodiments disclosed herein are illustrative and non-restrictive in every respect. The scope of the present disclosure is defined by the terms of the claims, rather than the description above, and is intended to include any modifications within the scope and meaning equivalent to the terms of the claims.

### REFERENCE SIGNS LIST

1 wireless terminal; ANT1 first antenna; ANT2 second antenna; ANT3 third antenna; ANT4 fourth antenna; 5, 105 radio frequency transceiver; 6, 206, 306 baseband processing unit; 32 first multiplexer; 33 second multiplexer; T31, T41 first terminal; T32, T42 second terminal; T33, T43 third terminal; T34, T44 fourth terminal; T35, T45 fifth terminal; 42, 62 first transmission filter; 43, 63 first reception filter; 44, 64 second transmission filter; 45, 65 second reception filter; 47, 48 terminating resistor; 21 first RF transceiver IC; 22 second RF transceiver IC; 25 third multiplexer; and 26 filter

1. A wireless terminal capable of transmission using a first frequency band and a second frequency band and reception using a third frequency band and a fourth frequency band, the wireless terminal comprising:
a first antenna;
a second antenna;
a radio frequency transceiver configured to convert a frequency of two systems of upstream baseband signals and output a transmission signal in the first frequency band and a transmission signal in the second frequency band;
a baseband processing unit which subjects a downstream signal received from the radio frequency transceiver and an upstream signal to be output to the radio frequency transceiver to baseband processing;
a first multiplexer configured to receive the transmission signal in the first frequency band from the radio frequency transceiver and output the transmission signal to the first antenna and configured to receive a signal from the first antenna and output a reception signal in the third frequency band and a reception signal in the fourth frequency band to the radio frequency transceiver; and
a second multiplexer configured to receive the transmission signal in the second frequency band from the radio frequency transceiver and output the transmission signal to the second antenna and configured to receive a signal from the second antenna and output a reception signal in the third frequency band and a reception signal in the fourth frequency band to the radio frequency transceiver,
the radio frequency transceiver being configured to generate a first signal and a second signal by converting a frequency of the reception signal in the third frequency band output from the first multiplexer and the reception signal in the third frequency band output from the second multiplexer into baseband signals and to generate a third signal and a fourth signal by converting a frequency of the reception signal in the fourth frequency band output from the first multiplexer and the reception signal in the fourth frequency band output from the second multiplexer into baseband signals, and
the baseband processing unit being configured to obtain two systems of downstream baseband signals by subjecting the first signal and the second signal to MIMO reception processing and subjecting the third signal and the fourth signal to MIMO reception processing.

2. The wireless terminal according to claim 1, wherein
the baseband processing unit is configured to generate the two systems of the upstream baseband signals by dividing transmission data and output the baseband signals to the radio frequency transceiver and configured to integrate the two systems of the downstream baseband signals.

3. The wireless terminal according to claim 1, wherein the first multiplexer includes
a first terminal connected to the first antenna,
a second terminal which receives the transmission signal in the first frequency band,
a third terminal which outputs the reception signal in the third frequency band,
a fourth terminal terminated by a terminating resistor,
a fifth terminal which outputs the reception signal in the fourth frequency band,
a first transmission filter which has a characteristic to allow passage of the first frequency band and is located between the first terminal and the second terminal,
a first reception filter which has a characteristic to allow passage of the third frequency band and is located between the first terminal and the third terminal,
a second transmission filter located between the first terminal and the fourth terminal, and
a second reception filter which has a characteristic to allow passage of the fourth frequency band and is located between the first terminal and the fifth terminal.

4. The wireless terminal according to claim 1, wherein
the second multiplexer includes
a first terminal connected to the second antenna,
a second terminal terminated by a terminating resistor,
a third terminal which outputs the reception signal in the third frequency band,
a fourth terminal which receives the transmission signal in the second frequency band,
a fifth terminal which outputs the reception signal in the fourth frequency band,
a first transmission filter located between the first terminal and the second terminal,
a first reception filter which has a characteristic to allow passage of the third frequency band and is located between the first terminal and the third terminal,
a second transmission filter which has a characteristic to allow passage of the second frequency band and is located between the first terminal and the fourth terminal, and
a second reception filter which has a characteristic to allow passage of the fourth frequency band and is located between the first terminal and the fifth terminal.

5. The wireless terminal according to claim 1, wherein
the radio frequency transceiver includes
a first RF transceiver IC configured to convert a frequency of a first baseband signal and output the transmission signal in the first frequency band and configured to convert a frequency of the reception signal in the third frequency band output from the first multiplexer and the reception signal in the third frequency band output from the second multiplexer into baseband signals, and
a second RF transceiver IC configured to convert a frequency of a second baseband signal and output the transmission signal in the second frequency band and configured to convert a frequency of the reception signal in the fourth frequency band output from the first multiplexer and the reception signal in the fourth frequency band output from the second multiplexer into baseband signals.

6. The wireless terminal according to claim 1, wherein
each of the first frequency band and the third frequency band is personal communications service (PCS) 1900 band, and
each of the second frequency band and the fourth frequency band is advanced wireless service (AWS) 1700 band.

7. The wireless terminal according to claim 1, wherein
each of the first frequency band and the third frequency band is international mobile telecommunication (IMT) 2100 band, and
each of the second frequency band and the fourth frequency band is digital cellular service (DCS) 1800 band.

8. The wireless terminal according to claim 1, the wireless terminal being capable of transmission using the first frequency band, the second frequency band, and a fifth frequency band and reception using the third frequency band, the fourth frequency band, and a sixth frequency band, wherein
the radio frequency transceiver is further configured to convert a frequency of another system of a baseband signal and output a transmission signal in the fifth frequency band,
the wireless terminal further comprises:
a third antenna;
a fourth antenna;
a third multiplexer configured to receive the transmission signal in the fifth frequency band from the radio frequency transceiver and output the transmission signal to the third antenna and configured to receive a signal from the third antenna and output a reception signal in the sixth frequency band to the radio frequency transceiver; and
a filter configured to receive a signal from the fourth antenna and output the reception signal in the sixth frequency band to the radio frequency transceiver,
the radio frequency transceiver is further configured to generate a fifth signal and a sixth signal by converting a frequency of the reception signal in the sixth frequency band output from the third multiplexer and the reception signal in the sixth frequency band output from the filter into baseband signals, and
the baseband processing unit is further configured to obtain additional one system of a downstream baseband signal by subjecting the fifth signal and the sixth signal to MIMO reception processing.

9. The wireless terminal according to claim 8, wherein
each of the first frequency band and the third frequency band is personal communications service (PCS) 1900 band,
each of the second frequency band and the fourth frequency band is advanced wireless service (AWS) 1700 band, and
each of the fifth frequency band and the sixth frequency band is SMH 700 band.

10. A method of wireless communication by a wireless terminal capable of transmission using a first frequency band and a second frequency band and reception using a third frequency band and a fourth frequency band, the wireless terminal including a first antenna, a second antenna, a radio frequency transceiver, a first multiplexer, a second multiplexer, and a baseband processing unit, the method of wireless communication comprising:
the radio frequency transceiver converting a frequency of two systems of upstream baseband signals and outputting a transmission signal in the first frequency band and a transmission signal in the second frequency band;
the first multiplexer receiving the transmission signal in the first frequency band from the radio frequency transceiver and outputting the transmission signal to the first antenna and receiving a signal from the first antenna and outputting a reception signal in the third frequency band and a reception signal in the fourth frequency band to the radio frequency transceiver, the second multiplexer receiving the transmission signal in the second frequency band from the radio frequency transceiver and outputting the transmission signal to the second antenna and receiving a signal from the second antenna and outputting a reception signal in the third frequency band and a reception signal in the fourth frequency band to the radio frequency transceiver;
the radio frequency transceiver generating a first signal and a second signal by converting a frequency of the reception signal in the third frequency band output from the first multiplexer and the reception signal in the third frequency band output from the second multiplexer into baseband signals and generating a third signal and a fourth signal by converting a frequency of the reception signal in the fourth frequency band output from the first multiplexer and the reception signal in the fourth frequency band output from the second multiplexer into baseband signals; and
the baseband processing unit obtaining two systems of downstream baseband signals by subjecting the first signal and the second signal to MIMO reception processing and subjecting the third signal and the fourth signal to MIMO reception processing.
